(19) United States
(12) Patent Application Publication
(10) Pub. No.: US 2015/0172715 A1
(43) Pub. Date: Jun. 18, 2015

(54) PICTURE ENCODING METHOD, PICTURE DECODING METHOD, PICTURE ENCODING APPARATUS, PICTURE DECODING APPARATUS, PICTURE ENCODING PROGRAM, PICTURE DECODING PROGRAM, AND RECORDING MEDIA

(71) Applicant: NIPPON TELEGRAPH AND TELEPHONE CORPORATION, Tokyo (JP)

(72) Inventors: Shinya Shimizu, Yokosuka-shi (JP); Shiori Sugimoto, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/412,867

(22) PCT Filed: Jul. 9, 2013
(86) PCT No.: PCT/JP2013/068728

§ 371 Date: Jan. 5, 2015

(30) Foreign Application Priority Data
Jul. 9, 2012 (JP) 2012-154065

(51) Int. Cl. H04N 19/597; H04N 19/513; H04N 19/523; H04N 19/52

(52) U.S. Cl. CPC H04N 19/597; H04N 19/52; H04N 19/521; H04N 19/523

(57) ABSTRACT

High coding efficiency is achieved when disparity-compensated prediction is performed on an encoding (decoding) target picture using depth information representing a three-dimensional position of an object in a reference picture. A correspondence point on the reference picture is set for each pixel of the encoding target picture. Object depth information which is depth information for a pixel at an integer pixel position on the encoding target picture indicated by the correspondence point is set. A tap length for pixel interpolation is determined using reference picture depth information for a pixel at an integer pixel position or an integer pixel position around a fractional pixel position on the reference picture indicated by the correspondence point and the object depth information. A pixel value at the integer pixel position or the fractional pixel position on the reference picture indicated by the correspondence point is generated using an interpolation filter in accordance with the tap length. Inter-view picture prediction is performed by setting the generated pixel value as a predicted value of the pixel at the integer pixel position on the encoding target picture indicated by the correspondence point.

### TECHNICAL FIELD

The present invention relates to a picture encoding method, a picture decoding method, a picture encoding apparatus, a picture decoding apparatus, a picture encoding program, a picture decoding program, and recording media for encoding and decoding a multiview picture.

Priority is claimed on Japanese Patent Application No. 2012-154065, filed Jul. 9, 2012, the content of which is incorporated herein by reference.

### BACKGROUND ART

A multiview picture refers to a plurality of pictures obtained by photographing the same object and background using a plurality of cameras, and a multiview moving picture (multiview video) refers to a moving picture thereof. Hereinafter, a picture (moving picture) captured by one camera is referred to as a “two-dimensional picture (moving picture)”, and a group of two-dimensional pictures (moving pictures) obtained by photographing the same object and background is referred to as a “multiview picture (moving picture)”. The two-dimensional moving picture has a strong correlation in a temporal direction, and coding efficiency is improved using the correlation.

On the other hand, when cameras are synchronized with each other, frames (pictures) corresponding to the same time in videos of the cameras in a multiview picture or a multiview moving picture are those obtained by photographing an object and background in completely the same state from different positions, and thus there is a strong correlation between the cameras. It is possible to improve coding efficiency in coding of a multiview picture or a multiview moving picture by using the correlation.

Here, conventional technology relating to encoding technology of two-dimensional moving pictures will be described. In many conventional two-dimensional moving picture coding schemes including H.264, MPEG-2, and MPEG-4, which are international coding standards, highly efficient encoding is performed using technologies of motion compensation, orthogonal transform, quantization, and entropy encoding. For example, in H.264, encoding using a temporal correlation with a plurality of past or future frames is possible.

Details of the motion compensation technology used in H.264, for example, are disclosed in Patent Document 1. An outline thereof will be described. The motion compensation of H.264 enables an encoding target frame to be divided into blocks of various sizes and enables the blocks to have different motion vectors and different reference pictures. Furthermore, video of a ½ pixel position and a ¼ pixel position is generated by performing a filtering process on a reference picture and more efficient coding than that of the conventional international coding standard scheme is achieved by enabling motion compensation of ¼ pixel accuracy.

Next, a conventional coding scheme for multiview pictures and multiview moving pictures will be described. A difference between a multiview picture coding method and a multiview moving picture coding method is that a correlation in the temporal direction and the inter-camera correlation are simultaneously present in a multiview moving picture. However, the same method using the inter-camera correlation can be used in both cases. Therefore, here, a method to be used in coding multiview moving pictures will be described.

In order to use the inter-camera correlation in the coding of multiview moving pictures, there is a conventional scheme of coding a multiview moving picture with high efficiency through “disparity compensation” in which motion compensation is applied to pictures captured by different cameras at the same time. Here, the disparity is a difference between positions at which the same portion on an object is present on picture planes of cameras arranged at different positions. FIG. 16 is a conceptual diagram of the disparity occurring between the cameras. In the conceptual diagram illustrated in FIG. 16, picture planes of cameras having parallel optical axes face down vertically. In this manner, the positions at which the same portion on the object is projected on the picture planes of the different cameras are generally referred to as correspondence points.

In the disparity compensation, each pixel value of the encoding target frame is predicted from the reference frame based on the correspondence relationship, and a predictive residue thereof and disparity information representing the correspondence relationship are encoded. Because the disparity varies from one picture of a target camera to another picture of the target camera, it is necessary to encode disparity information for each encoding processing target frame. Actually, in the multiview coding scheme of H.264, the disparity information is encoded for each frame (more accurately, for each block which uses disparity-compensated prediction).

The correspondence relationship obtained by the disparity information can be represented as a one-dimensional value representing a three-dimensional position of an object, rather than as a two-dimensional vector, by using camera parameters based on epipolar geometric constraints. Although there are various representations as information representing a three-dimensional position of an object, the distance from a reference camera to the object or coordinate values on an axis which is not parallel to a picture plane of the camera is normally used. It is to be noted that the reciprocal of a distance may be used instead of the distance. In addition, because the reciprocal of the distance is information proportional to the disparity, two reference cameras may be set and a three-dimensional position of the object may be represented as a disparity amount between pictures captured by these cameras. Because there is no essential difference in a physical meaning regardless of what representation is used, information representing a three-dimensional position is hereinafter represented as depth without distinction of representation.

FIG. 17 is a conceptual diagram of epipolar geometric constraints. According to the epipolar geometric constraints, a point on a picture of a certain camera corresponding to a point on a picture of another camera is constrained on a straight line called an epipolar line. At this time, when the depth of its pixel is obtained, the correspondence point is uniquely defined on the epipolar line. For example, as illustrated in FIG. 17, a correspondence point in a picture of a camera B for an object projected at a position m in a picture of a camera A is projected at a position m′ on the epipolar line when the position of the object in a real space is M′ and it is projected at a position m″ on the epipolar line when the position of the object in the real space is M″.

FIG. 18 is a diagram illustrating that correspondence points are obtained between pictures of a plurality of cameras when depth is given to a picture of one of the cameras. The depth is information representing a three-dimensional position of the object and the three-dimensional position is determined by the physical position of the object, and thus the depth is not information that depends upon a camera. Therefore, it is possible to represent correspondence points on pictures of a plurality of camera by one piece of information, i.e., the depth. For example, as illustrated in FIG. 18, when the distance D from a view position of the camera A to a point on the object is given as depth, it is possible to represent both a correspondence point m_{b} on a picture of the camera B and a correspondence point m_{c} on a picture of the camera C for a point mₐ on a picture of the camera A by identifying a point M on the object from the depth. According to this property, it is possible to implement disparity compensation for all frames captured by other cameras (for which a positional relationship between the cameras is obtained) at the same time from a reference picture by representing the disparity information using depth for the reference picture.

Non-Patent Document 2 uses this property to reduce an amount of disparity information necessary for coding, thereby achieving highly efficient multiview moving picture coding. It is known that highly accurate prediction can be performed by using a more detailed correspondence relationship than an integer pixel unit when motion-compensated prediction or disparity-compensated prediction is used. For example, H.264 achieves efficient coding by using a correspondence relationship of a ¼ pixel unit as described above. Therefore, even when depth for a pixel of a reference picture is given, there is a method for improving prediction accuracy by giving more detailed depth.

If the accuracy of the depth is increased when the depth is given to a pixel of a reference picture, the position on the encoding target picture corresponding to the pixel on the reference picture is obtained in further detail, but the position on the reference picture corresponding to the pixel on the encoding target picture is not obtained in further detail. To address this problem, Patent Document 1 improves prediction accuracy by translating a correspondence relationship and employing the translated correspondence relationship as detailed disparity information for a pixel on an encoding target picture while maintaining the magnitude of the disparity.

### PRIOR ART DOCUMENTS

### Patent Document

Patent Document 1: PCT International Publication No. WO 08/035665

### Non-Patent Documents

Non-Patent Document 1: ITU-T Recommendation H.264 (03/2009), “Advanced video coding for generic audiovisual services”, March 2009.
Non-Patent Document 2: Shinya SHIMIZU, Masaki KITAHARA, Kazuto KAMIKURA, and Yoshiyuki YASHIMA, “Multiview Video Coding based on 3-D Warping with Depth Map”, In Proceedings of Picture Coding Symposium 2006, SS3-6, April 2006.

### SUMMARY OF INVENTION

### Problems to be Solved by the Invention

According to the method of Patent Document 1, it is definitely possible to obtain a position of fractional pixel accuracy on a reference picture corresponding to a position of an integer pixel of an encoding (decoding) target picture from correspondence point information for the encoding (decoding) target picture which is given by using an integer pixel of the reference picture as a reference. Thus, it is possible to achieve disparity-compensated prediction having higher accuracy and achieve highly efficient multiview picture (moving picture) coding by generating a predicted picture using a pixel value of a fractional pixel position obtained by performing interpolation from pixel values of integer pixel positions. The interpolation of the pixel value for the fractional pixel position is performed by obtaining a weighted average of pixel values of peripheral integer pixel positions. At this time, in order to achieve more natural interpolation, it is necessary to use weight coefficients considering spatial continuity, that is, distances and interpolated pixels. In a scheme of obtaining a pixel value of a fractional pixel position on a reference picture, all positional relationships of pixels used in the interpolation and the interpolated pixels are assumed to be the same even on the encoding (decoding) target picture.

However, in practice, it is not ensured that the positional relationships of the pixels are the same, and there is a problem in that the quality of the interpolated pixels is significantly bad in the case in which the assumption does not hold. When the distance between a pixel to be used for the interpolation and a pixel serving as an interpolation target is farther, the positional relationship between the reference picture and the encoding (decoding) target picture is more likely to be changed. Therefore, it is conceivable that a countermeasure of suppressing the occurrence of the case in which the above-described assumption is not established is taken against the above-described problem by using only pixels adjacent to the pixel serving as the interpolation target in the interpolation. However, because it is generally possible to achieve higher performance interpolation when the number of pixels to be used in the interpolation is further increased, the interpolation performance of such an easily conceivable technique is remarkably low even if incorrect interpolation is unlikely to be performed.

In addition, there is also a method for obtaining all corresponding points on the encoding (decoding) target picture for pixels to be used for interpolation are obtained and then determining weights in accordance with positional relationships between the correspondence points and a pixel of an interpolation target on the encoding (decoding) target picture. However, there is a problem in that calculation cost significantly increases because it is necessary to obtain correspondence points on the encoding (decoding) target picture for a plurality of pixels on the reference picture for each interpolation pixel.

The present invention has been made in view of such circumstances and an object thereof is to provide a picture encoding method, a picture decoding method, a picture encoding apparatus, a picture decoding apparatus, a picture encoding program, a picture decoding program, and recording media capable of achieving high coding efficiency when disparity-compensated prediction is performed on an encoding (decoding) target picture using depth information representing a three-dimensional position of an object in a reference picture.

### Means for Solving the Problems

The present invention is a picture encoding method for performing encoding while predicting a picture between a plurality of views using a reference picture encoded for a view different from a view of an encoding target picture and reference picture depth information which is depth information of an object in the reference picture when a multiview picture which includes pictures from the views is encoded, and the method includes: a correspondence point setting step of setting a correspondence point on the reference picture for each pixel of the encoding target picture; an object depth information setting step of setting object depth information which is depth information for a pixel at an integer pixel position on the encoding target picture indicated by the correspondence point; an interpolation tap length determining step of determining a tap length for pixel interpolation using the reference picture depth information for a pixel at an integer pixel position or an integer pixel position around a fractional pixel position on the reference picture indicated by the correspondence point and the object depth information; a pixel interpolating step of generating a pixel value at the integer pixel position or the fractional pixel position on the reference picture indicated by the correspondence point using an interpolation filter in accordance with the tap length; and an inter-view picture predicting step of performing inter-view picture prediction by setting the pixel value generated in the pixel interpolating step as a predicted value of the pixel at the integer pixel position on the encoding target picture indicated by the correspondence point.

The present invention is a picture encoding method for performing encoding while predicting a picture between a plurality of views using a reference picture encoded for a view different from a view of an encoding target picture and reference picture depth information which is depth information of an object in the reference picture when a multiview picture which includes pictures from the views is encoded, and the method includes: a correspondence point setting step of setting a correspondence point on the reference picture for each pixel of the encoding target picture; an object depth information setting step of setting object depth information which is depth information for a pixel at an integer pixel position on the encoding target picture indicated by the correspondence point; an interpolation reference pixel setting step of setting pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information; a pixel interpolating step of generating a pixel value at the integer pixel position or the fractional pixel position on the reference picture indicated by the correspondence point in accordance with a weighted sum of pixel values of the interpolation reference pixels; and an inter-view picture predicting step of performing inter-view picture prediction by setting the pixel value generated in the pixel interpolating step as a predicted value of the pixel at the integer pixel position on the encoding target picture indicated by the correspondence point.

Preferably, the present invention further includes an interpolation coefficient determining step of determining interpolation coefficients for the interpolation reference pixels based on a difference between the reference picture depth information for the interpolation reference pixels and the object depth information for each of the interpolation reference pixels, wherein the interpolation reference pixel setting step sets the pixel at the integer pixel position or the integer pixel position around the fractional pixel position on the reference picture indicated by the correspondence point as the interpolation reference pixels, and the pixel interpolating step generates the pixel value at the integer pixel position or the fractional pixel position on the reference picture indicated by the correspondence point by obtaining the weighted sum of the pixel values of the interpolation reference pixels based on the interpolation coefficients.

Preferably, the present invention further includes an interpolation tap length determining step of determining a tap length for pixel interpolation using the reference picture depth information for the pixel at the integer pixel position or the integer pixel position around the fractional pixel position on the reference picture indicated by the correspondence point and the object depth information, wherein the interpolation reference pixel setting step sets pixels present in a range of the tap length as the interpolation reference pixels.

Preferably, in the present invention, the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines the interpolation coefficient based on the difference if the magnitude of the difference is within the threshold value.

Preferably, in the present invention, the interpolation coefficient determining step determines an interpolation coefficient based on a difference between the reference picture depth information for one of the interpolation reference pixels and the object depth information and a distance between one of the interpolation reference pixels and an integer pixel or a fractional pixel on the reference picture indicated by the correspondence point.

Preferably, in the present invention, the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines an interpolation coefficient based on the difference and a distance between one of the interpolation reference pixels and an integer pixel or a fractional pixel on the reference picture indicated by the correspondence point if the magnitude of the difference is within the predetermined threshold value.

The present invention is a picture decoding method for performing decoding while predicting a picture between views using a decoded reference picture and reference picture depth information which is depth information of an object in the reference picture when a decoding target picture of a multiview picture is decoded, and the method includes: a correspondence point setting step of setting a correspondence point on the reference picture for each pixel of the decoding target picture; an object depth information setting step of setting object depth information which is depth information for a pixel at an integer pixel position on the decoding target picture indicated by the correspondence point; an interpolation tap length determining step of determining a tap length for pixel interpolation using the reference picture depth information for a pixel at an integer pixel position or an integer pixel position around a fractional pixel position on the reference picture indicated by the correspondence point and the object depth information; a pixel interpolating step of generating a pixel value at the integer pixel position or the fractional pixel position on the reference picture indicated by the correspondence point using an interpolation filter in accordance with the tap length; and an inter-view picture predicting step of performing inter-view picture prediction by setting the pixel value generated in the pixel interpolating step as a predicted value of the pixel at the integer pixel position on the decoding target picture indicated by the correspondence point.

The present invention is a picture decoding method for performing decoding while predicting a picture between views using a decoded reference picture and reference picture depth information which is depth information of an object in the reference picture when a decoding target picture of a multiview picture is decoded, and the method includes: a correspondence point setting step of setting a correspondence point on the reference picture for each pixel of the decoding target picture; an object depth information setting step of setting object depth information which is depth information for a pixel at an integer pixel position on the decoding target picture indicated by the correspondence point; an interpolation reference pixel setting step of setting pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information; a pixel interpolating step of generating a pixel value at the integer pixel position or the fractional pixel position on the reference picture indicated by the correspondence point in accordance with a weighted sum of pixel values of the interpolation reference pixels; and an inter-view picture predicting step of performing inter-view picture prediction by setting the pixel value generated in the pixel interpolating step as a predicted value of the pixel at the integer pixel position on the decoding target picture indicated by the correspondence point.

Preferably, the present invention further includes an interpolation coefficient determining step of determining interpolation coefficients for the interpolation reference pixels based on a difference between the reference pixel depth information for the interpolation reference pixels and the object depth information for each of the interpolation reference pixels, wherein the interpolation reference pixel setting step sets the pixel at the integer pixel position or the integer pixel position around the fractional pixel position on the reference picture indicated by the correspondence point as the interpolation reference pixels, and the pixel interpolating step generates the pixel value at the integer pixel position or the fractional pixel position on the reference picture indicated by the correspondence point by obtaining the weighted sum of the pixel values of the interpolation reference pixels based on the interpolation coefficients.

Preferably, the present invention further includes an interpolation tap length determining step of determining a tap length for pixel interpolation using the reference picture depth information for the pixel at the integer pixel position or the integer pixel position around the fractional pixel position on the reference picture indicated by the correspondence point and the object depth information, wherein the interpolation reference pixel setting step sets pixels present in a range of the tap length as the interpolation reference pixels.

Preferably, in the present invention, the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines the interpolation coefficient based on the difference if the magnitude of the difference is within the threshold value.

Preferably, in the present invention, the interpolation coefficient determining step determines an interpolation coefficients based on a difference between the reference picture depth information for one of the interpolation reference pixels and the object depth information and a distance between one of the interpolation reference pixels and an integer pixel or a fractional pixel on the reference picture indicated by the correspondence point.

Preferably, in the present invention, the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines an interpolation coefficient based on the difference and a distance between one of the interpolation reference pixels and an integer pixel or a fractional pixel on the reference picture indicated by the correspondence point if the magnitude of the difference is within the predetermined threshold value.

The present invention is a picture encoding apparatus for performing encoding while predicting a picture between a plurality of views using a reference picture encoded for a view different from a view of an encoding target picture and reference picture depth information which is depth information of an object in the reference picture when a multiview picture which includes pictures from the views is encoded, and the apparatus includes: a correspondence point setting unit which sets a correspondence point on the reference picture for each pixel of the encoding target picture; an object depth information setting unit which sets object depth information which is depth information for a pixel at an integer pixel position on the encoding target picture indicated by the correspondence point; an interpolation tap length determining unit which determines a tap length for pixel interpolation using the reference picture depth information for a pixel at an integer pixel position or an integer pixel position around a fractional pixel position on the reference picture indicated by the correspondence point and the object depth information; a pixel interpolating unit which generates a pixel value at the integer pixel position or the fractional pixel position on the reference picture indicated by the correspondence point using an interpolation filter in accordance with the tap length; and an inter-view picture predicting unit which performs inter-view picture prediction by setting the pixel value generated by the pixel interpolating unit as a predicted value of the pixel at the integer pixel position on the encoding target picture indicated by the correspondence point.

The present invention is a picture encoding apparatus for performing encoding while predicting a picture between a plurality of views using a reference picture encoded for a view different from a view of an encoding target picture and reference picture depth information which is depth information of an object in the reference picture when a multiview picture which includes pictures from the views is encoded, and the apparatus includes: a correspondence point setting unit which sets a correspondence point on the reference picture for each pixel of the encoding target picture; an object depth information setting unit which sets object depth information which is depth information for a pixel at an integer pixel position on the encoding target picture indicated by the correspondence point; an interpolation reference pixel setting unit which sets pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information; a pixel interpolating unit which generates a pixel value at the integer pixel position or the fractional pixel position on the reference picture indicated by the correspondence point in accordance with a weighted sum of pixel values of the interpolation reference pixels; and an inter-view picture predicting unit which performs inter-view picture prediction by setting the pixel value generated by the pixel interpolating unit as a predicted value of the pixel at the integer pixel position on the encoding target picture indicated by the correspondence point.

The present invention is a picture decoding apparatus for performing decoding while predicting a picture between views using a decoded reference picture and reference picture depth information which is depth information of an object in the reference picture when a decoding target picture of a multiview picture is decoded, and the apparatus includes: a correspondence point setting unit which sets a correspondence point on the reference picture for each pixel of the decoding target picture; an object depth information setting unit which sets object depth information which is depth information for a pixel at an integer pixel position on the decoding target picture indicated by the correspondence point; an interpolation tap length determining unit which determines a tap length for pixel interpolation using the reference picture depth information for a pixel at an integer pixel position or an integer pixel position around a fractional pixel position on the reference picture indicated by the correspondence point and the object depth information; a pixel interpolating unit which generates a pixel value at the integer pixel position or the fractional pixel position on the reference picture indicated by the correspondence point using an interpolation filter in accordance with the tap length; and an inter-view picture predicting unit which performs inter-view picture prediction by setting the pixel value generated by the pixel interpolating unit as a predicted value of the pixel at the integer pixel position on the decoding target picture indicated by the correspondence point.

The present invention is a picture decoding apparatus for performing decoding while predicting a picture between views using a decoded reference picture and reference picture depth information which is depth information of an object in the reference picture when a decoding target picture of a multiview picture is decoded, and the apparatus includes: a correspondence point setting unit which sets a correspondence point on the reference picture for each pixel of the decoding target picture; an object depth information setting unit which sets object depth information which is depth information for a pixel at an integer pixel position on the decoding target picture indicated by the correspondence point; an interpolation reference pixel setting unit which sets pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information; a pixel interpolating unit which generates a pixel value at the integer pixel position or the fractional pixel position on the reference picture indicated by the correspondence point in accordance with a weighted sum of pixel values of the interpolation reference pixels; and an inter-view picture predicting unit which performs inter-view picture prediction by setting the pixel value generated by the pixel interpolating unit as a predicted value of the pixel at the integer pixel position on the decoding target picture indicated by the correspondence point.

The present invention is a picture encoding program for causing a computer to execute the picture encoding method.

The present invention is a picture decoding program for causing a computer to execute the picture decoding method.

The present invention is a computer-readable recording medium recording the picture encoding program.

The present invention is a computer-readable recording medium recording the picture decoding program.

### Advantageous Effects of Invention

According to the present invention, there is an advantageous effect in that it is possible to achieve generation of a higher quality predicted picture and highly efficient picture coding of a multiview picture by interpolating a pixel value in consideration of a distance in a three-dimensional space.

### BRIEF DESCRIPTION OF DRAWINGS

FIG. 1 is a diagram illustrating a configuration of a picture encoding apparatus in a first embodiment of the present invention.

FIG. 2 is a flowchart illustrating an operation of a picture encoding apparatus 100 illustrated in FIG. 1.

FIG. 3 is a block diagram illustrating a configuration of a disparity compensated picture generating unit 110 illustrated in FIG. 1.

FIG. 4 is a flowchart illustrating a processing operation of a process (disparity compensated picture generating process: step S103) performed by a correspondence point setting unit 109 illustrated in FIG. 1 and the disparity compensated picture generating unit 110 illustrated in FIG. 3.

FIG. 5 is a diagram illustrating a modified example of a configuration of the disparity compensated picture generating unit 110, which generates a disparity compensated picture.

FIG. 6 is a flowchart illustrating an operation of the disparity compensated picture processing (step S103) performed by the correspondence point setting unit 109 and the disparity compensated picture generating unit 110 illustrated in FIG. 5.

FIG. 7 is a diagram illustrating a modified example of a configuration of the disparity compensated picture generating unit 110, which generates a disparity compensated picture.

FIG. 8 is a flowchart illustrating an operation of the disparity compensated picture processing (step S103) performed by the correspondence point setting unit 109 and the disparity compensated picture generating unit 110 illustrated in FIG. 7.

FIG. 9 is a diagram illustrating a configuration example of a picture encoding apparatus 100a when only reference picture depth information is used.

FIG. 10 is a flowchart illustrating an operation of disparity compensated picture processing performed by the picture encoding apparatus 100a illustrated in FIG. 9.

FIG. 11 is a diagram illustrating a configuration example of a picture decoding apparatus in accordance with a third embodiment of the present invention.

FIG. 12 is a flowchart illustrating a processing operation of a picture decoding apparatus 200 illustrated in FIG. 11.

FIG. 13 is a diagram illustrating a configuration example of a picture decoding apparatus 200a when only reference picture depth information is used.

FIG. 14 is a diagram illustrating a configuration example of hardware when the picture encoding apparatus is configured by a computer and a software program.

FIG. 15 is a diagram illustrating a configuration example of hardware when the picture decoding apparatus is configured by a computer and a software program.

FIG. 16 is a conceptual diagram of disparity which occurs between cameras.

FIG. 17 is a conceptual diagram of epipolar geometric constraints.

FIG. 18 is a diagram illustrating that correspondence points are obtained between pictures from a plurality of cameras when depth is given to a picture from one of the cameras.

### MODES FOR CARRYING OUT THE INVENTION

Hereinafter, picture encoding apparatuses and picture decoding apparatuses in accordance with embodiments of the present invention will be described with reference to the drawings. In the following description, the case in which a multiview picture captured by two cameras including a first camera (referred to as a camera A) and a second camera (referred to as a camera B) is encoded is assumed and a picture of the camera B is encoded or decoded using a picture of the camera A as a reference picture. It is to be noted that information necessary for obtaining a disparity from depth information is assumed to be separately given. Specifically, this information is an external parameter representing a positional relationship between the cameras A and B or an internal parameter representing information on projection on a picture plane by a camera, but other information in other forms may be given as long as a disparity is obtained from the depth information. Detailed description relating to these camera parameters, for example, is disclosed in the Document: Olivier Faugeras, “Three-Dimensional Computer Vision”, pp. 33 to 66, MIT Press; BCTC/UFF-006.37 F259 1993, ISBN: 0-262-06158-9. In this document, description relating to parameters representing a positional relationship between a plurality of cameras or a parameter representing information on projection on a picture plane by a camera is disclosed.

### First Embodiment

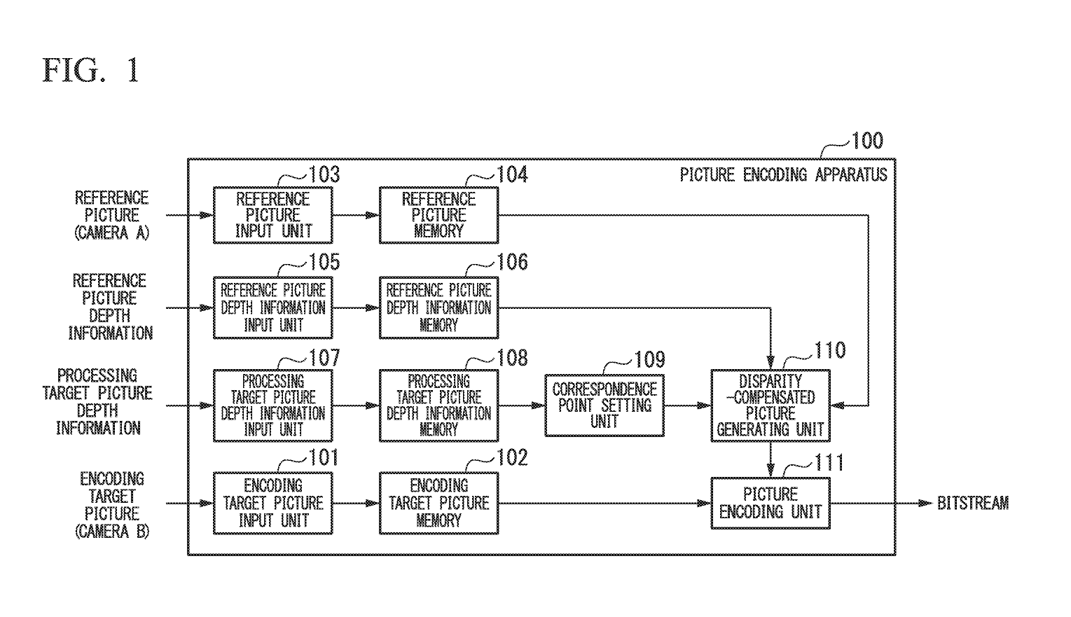

FIG. 1 is a block diagram illustrating a configuration of a picture encoding apparatus in the first embodiment. As illustrated in FIG. 1, a picture encoding apparatus 100 includes an encoding target picture input unit 101, an encoding target picture memory 102, a reference picture input unit 103, a reference picture memory 104, a reference picture depth information input unit 105, a reference picture depth information memory 106, a processing target picture depth information input unit 107, a processing target picture depth information memory 108, a correspondence point setting unit 109, a disparity compensated picture generating unit 110, and a picture encoding unit 111.

The encoding target picture input unit 101 inputs a picture serving as an encoding target. Hereinafter, a picture serving as an encoding target is referred to as an encoding target picture. Here, a picture of the camera B is input. The encoding target picture memory 102 stores the input encoding target picture. The reference picture input unit 103 inputs a picture serving as a reference picture when a disparity compensated picture is generated. Here, a picture of the camera A is input. The reference picture memory 104 stores the input reference picture.

The reference picture depth information input unit 105 inputs depth information for the reference picture. Hereinafter, depth information for the reference picture is referred to as reference picture depth information. The reference picture depth information memory 106 stores the input reference picture depth information. The processing target picture depth information input unit 107 inputs depth information for the encoding target picture. Hereinafter, depth information for the encoding target picture is referred to as processing target picture depth information. The processing target picture depth information memory 108 stores the input processing target picture depth information.

It is to be noted that the depth information represents a three-dimensional position of an object shown in each pixel of the reference picture. In addition, the depth information may be any information as long as the three-dimensional position is obtained using separately given information such as camera parameters. For example, it is possible to use the distance from a camera to an object, coordinate values for an axis which is not parallel to a picture plane, or disparity information for another camera (for example, a camera B).

The correspondence point setting unit 109 sets a correspondence point on the reference picture for each pixel of the encoding target picture using the processing target picture depth information. The disparity compensated picture generating unit 110 generates a disparity compensated picture using the reference picture and information of the correspondence point. The picture encoding unit 111 performs predictive encoding on the encoding target picture using the disparity compensated picture as a predicted picture.

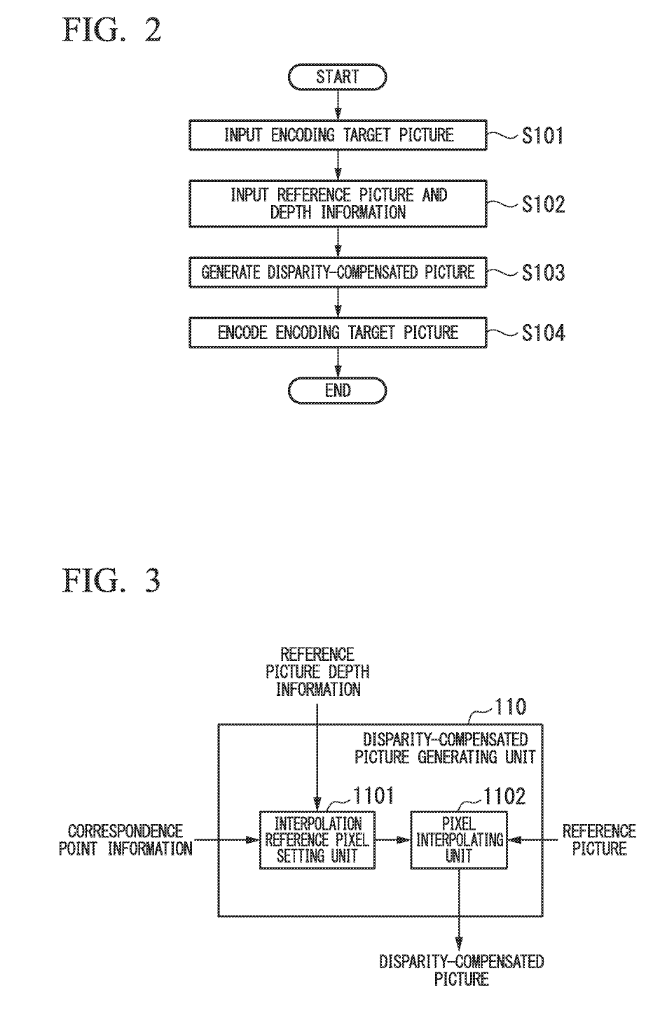

Next, an operation of the picture encoding apparatus 100 illustrated in FIG. 1 will be described with reference to FIG. 2. FIG. 2 is a flowchart illustrating the operation of the picture encoding apparatus 100 illustrated in FIG. 1. First, the encoding target picture input unit 101 inputs an encoding target picture and stores the input encoding target picture in the encoding target picture memory 102 (step S101). Next, the reference picture input unit 103 inputs a reference picture and stores the input reference picture in the reference picture memory 104. In parallel therewith, the reference picture depth information input unit 105 inputs reference picture depth information and stores the input reference picture depth information in the reference picture depth information memory 106. In addition, the processing target picture depth information input unit 107 inputs processing target picture depth information and stores the input processing target picture depth information in the processing target picture depth information memory 108 (step S102).

It is to be noted that the reference picture, the reference picture depth information, and the processing target picture depth information input in step S102 are assumed to be the same as those obtained by a decoding end such as those obtained by decoding previously encoded information. This is because the occurrence of coding noise such as a drift is suppressed by using information that is completely identical to that obtained by the decoding apparatus. However, when the occurrence of coding noise is allowed, information obtained by only an encoding end such as information that is not encoded may be input. With respect to the depth information, in addition to information obtained by decoding previously encoded information, information that is equally obtained by the decoding end, such as depth information generated from depth information decoded for another camera or depth information estimated by applying stereo matching or the like to a multiview picture decoded for a plurality of cameras, can be used.

Next, when the input has been completed, the correspondence point setting unit 109 generates a correspondence point or a correspondence block on the reference picture for each pixel or predetermined block of the encoding target picture using the reference picture, the reference picture depth information, and the processing target picture depth information. In parallel therewith, the disparity compensated picture generating unit 110 generates a disparity compensated picture (step S103). Details of the process here will be described later.

When the disparity compensated picture has been obtained, the picture encoding unit 111 performs predictive encoding on the encoding target picture using the disparity compensated picture as a predicted picture and outputs its result (step S104). A bitstream obtained by the encoding becomes an output of the picture encoding apparatus 100. It is to be noted that any method may be used in encoding as long as the decoding end can correctly perform decoding.

In general moving picture encoding or picture encoding such as MPEG-2, H.264, or JPEG, encoding is performed by dividing a picture into blocks each having a predetermined size, generating a difference signal between an encoding target picture and a predicted picture for each block, performing frequency conversion such as a discrete cosine transform (DCT) on a difference picture for each block, and sequentially applying processes of quantization, binarization, and entropy encoding on a resultant value for each block. It is to be noted that when the predictive encoding process is performed for each block, the encoding target picture may be encoded by iterating a disparity compensated picture generating process (step S103) and an encoding target picture encoding process (step S104) alternately for every block.

Next, a configuration of the disparity compensated picture generating unit 110 illustrated in FIG. 1 will be described with reference to FIG. 3. FIG. 3 is a block diagram illustrating a configuration of the disparity compensated picture generating unit 110 illustrated in FIG. 1. The disparity compensated picture generating unit 110 includes an interpolation reference pixel setting unit 1101 and a pixel interpolating unit 1102. The interpolation reference pixel setting unit 1101 determines a set of interpolation reference pixels which are pixels of the reference picture to be used for interpolating a pixel value of a correspondence point set by the correspondence point setting unit 109. The pixel interpolating unit 1102 interpolates a pixel value at a position of the correspondence point using pixel values of the reference picture for the set interpolation reference pixels.

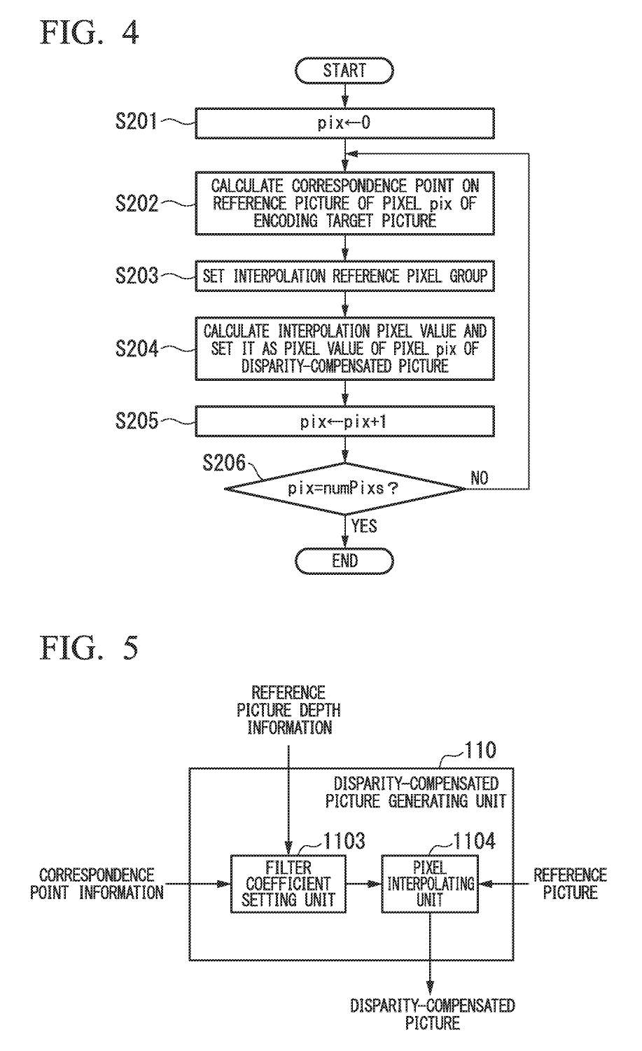

Next, a processing operation of the correspondence point setting unit 109 illustrated in FIG. 1 and the disparity compensated picture generating unit 110 illustrated in FIG. 3 will be described with reference to FIG. 4. FIG. 4 is a flowchart illustrating the processing operation of a process (disparity compensated picture generating process: step S103) performed by the correspondence point setting unit 109 illustrated in FIG. 1 and the disparity compensated picture generating unit 110 illustrated in FIG. 3. In this process, the disparity compensated picture for the entire encoding target picture is generated by iterating the process for every pixel. That is, when a pixel index is denoted as pix and the total number of pixels of the picture is denoted as numPixs, the disparity compensated picture is generated by initializing pix to 0 (step S201) and then iterating the following process (steps S202 to S205) until pix reaches numPixs (step S206) while pix is incremented by 1 (step S205).

Here, the process may be iterated for every region having a predetermined size instead of every pixel, or the disparity compensated picture may be generated for the region having the predetermined size instead of the entire encoding target picture. In addition, the disparity compensated picture may be generated for a region having the same or another predetermined size by combining both of them and iterating the process for every region having the predetermined size. Its processing flow corresponds to a processing flow obtained by replacing the pixel with a “block to be iteratively processed” and replacing the encoding target picture with a “target region in which the disparity compensated picture is generated” in the processing flow illustrated in FIG. 4. Implementation in which a unit in which the process is iterated is matched with a size corresponding to a unit in which the processing target picture depth information is given and implementation in which target regions in which the disparity compensated picture is generated are matched with regions when the encoding target picture is divided into the regions and predictive encoding is performed are also preferable.

In the process to be performed for every pixel, first, the correspondence point setting unit 109 obtains a correspondence point qₚᵢₓ on the reference picture for a pixel pix using processing target picture depth information dₚᵢₓ for the pixel pix (step S202). It is to be noted that although a process of calculating the correspondence point from the depth information is performed in accordance with the definition of the given depth information, any process may be used as long as a correct correspondence point represented by the depth information is obtained. For example, when the depth information is given as the distance from a camera to an object or coordinate values for an axis which is not parallel to a camera plane, it is possible to obtain the correspondence point by restoring a three-dimensional point for the pixel pix and projecting the three-dimensional point on the reference picture using camera parameters of a camera capturing the encoding target picture and a camera capturing the reference picture.

That is, when the depth information represents the distance from the camera to the object, the restoration of a three-dimensional point g is performed in accordance with the following Equation 1, projection on the reference picture is performed in accordance with Equation 2, and coordinates (x, y) of the correspondence point on the reference picture are obtained. Here, (uₚᵢₓ, vₚᵢₓ) represents coordinate values of the pixel pix on an encoding target picture. A_{X}, R_{X}, and t_{X} represent an intrinsic parameter, a rotation matrix, and a translation vector of a camera x (x is c or r). c represents the camera capturing the encoding target picture, and r represents the camera capturing the reference picture. It is to be noted that the set of the rotation matrix and the translation vector are referred to as an extrinsic camera parameter. In these equations, the extrinsic camera parameter represents conversion from the camera coordinate system to the world coordinate system, and it is necessary to use different equations accordingly when another definition is formed. distance (x, d) is a function of converting depth information d for the camera x into the distance from the camera x to the object, and it is given along with the definition of the depth information. The conversion may be defined using a lookup table instead of the function. k is an arbitrary real number which satisfies the equation.

### [Equation 1]

$$g = {R}_{c} {A}_{c}^{- 1} [ \begin{matrix}{u}_{pix} \\ {v}_{pix} \\ 1\end{matrix} ] distance ( c , {d}_{pix} ) + {t}_{c} \qquad ( Equation 1 )$$

### [Equation 2]

$$k [ \begin{matrix}x \\ y \\ 1\end{matrix} ] = {A}_{r} {R}_{r}^{- 1} ( g - {t}_{r} ) \qquad ( Equation 2 )$$

It is to be noted that although distance (c, dₚᵢₓ) in the Equation 1 is an undetermined number when the depth information is given as coordinate values for an axis which is not parallel to the camera plane, it is possible to restore the three-dimensional point using Equation 1 because g is represented by two variables due to a constraint that g is present on a certain plane.

In addition, a correspondence point may be obtained using a matrix referred to as a homography without involving the three-dimensional point. The homography is a 3×3 matrix which converts coordinate values on a certain picture into coordinate values on another picture for a point on a plane present in a three-dimensional space. That is, when the depth information is given as the distance from a camera to an object or as coordinate values for an axis which is not parallel to a camera plane, the homography becomes a matrix differing for the value of the depth information and coordinates of the correspondence point on the reference picture are obtained by the following Equation 3. H_{c,r,d} represents a homography which converts coordinate values on a picture of the camera c into coordinate values on a picture of the camera r with respect to a point on the three-dimensional plane corresponding to depth information d, and k′ is an arbitrary real number which satisfies the equation. It is to be noted that detailed description relating to the homography, for example, is disclosed in Olivier Faugeras, “Three-Dimensional Computer Vision”, pp. 206 to 211, MIT Press; BCTC/UFF-006.37 F259 1993, ISBN: 0-262-06158-9.

### [Equation 3]

$${k}^{′} [ \begin{matrix}x \\ y \\ 1\end{matrix} ] = {H}_{c , r , {d}_{pix}} [ \begin{matrix}{u}_{pix} \\ {v}_{pix} \\ 1\end{matrix} ] \qquad ( Equation 3 )$$

In addition, when the camera capturing the encoding target picture is the same as the camera capturing the reference picture and the cameras are arranged in the same direction, the following Equation 4 is obtained from Equations 1 and 2 because A_{c} becomes equal to Aᵣ and R_{c} becomes equal to Rᵣ. k″ is an arbitrary real number which satisfies the equation.

### [Equation 4]

$${k}^{″} [ \begin{matrix}x \\ y \\ 1\end{matrix} ] = [ \begin{matrix}{u}_{pix} \\ {v}_{pix} \\ 1\end{matrix} ] + \frac{{A}_{r} {R}_{r}^{- 1} ( {t}_{c} - {t}_{r} )}{distance ( c , {d}_{pix} )} \qquad ( Equation 4 )$$

Equation 4 represents that the difference between positions on the pictures, that is, a disparity, is in proportion to the reciprocal of the distance from the camera to the object. From this fact, it is possible to obtain the correspondence point by obtaining a disparity for the depth information serving as a reference and scaling the disparity in accordance with the depth information. At this time, because the disparity does not depend upon a position on a picture, in order to reduce the computational complexity, implementation in which a lookup table of the disparity for each piece of depth information is created and a disparity and a correspondence point are obtained by referring to the table is also preferable.

When the correspondence point qₚᵢₓ on the reference picture for the pixel pix is obtained, the interpolation reference pixel setting unit 1101 then determines a set (interpolation reference pixel group) of interpolation reference pixels for interpolating and generating a pixel value for the correspondence point on the reference picture using the reference picture depth information and the processing target picture depth information dₚᵢₓ for the pixel pix (step S203). It is to be noted that when the correspondence point on the reference picture is present at an integer pixel position, a pixel corresponding thereto is set as an interpolation reference pixel.

The interpolation reference pixel group may be determined as the distance from qₚᵢₓ, that is, a tap length of an interpolation filter, or determined as an arbitrary set of pixels. It is to be noted that the interpolation reference pixel group may be determined in a one-dimensional direction or a two-dimensional direction with respect to qₚᵢₓ. For example, when qₚᵢₓ is present at an integer position in the vertical direction, implementation which targets only pixels that are present in the horizontal direction with respect to qₚᵢₓ is also preferable.

Here, a method for determining the interpolation reference pixel group as a tap length will be described. First, a tap length which is one size greater than a predetermined minimum tap length is set as a temporary tap length. Next, a set of pixels around the point qₚᵢₓ to be referred to when a pixel value of the point qₚᵢₓ on the reference picture is interpolated using an interpolation filter of the temporary tap length is set as a temporary interpolation reference pixel group. If the number of pixels in which the difference between reference picture depth information rdₚ for a pixel p and dₚᵢₓ exceeds a predetermined threshold value which are present in the temporary interpolation reference pixel group is greater than a separately determined number, a length less than the temporary tap length by one is set as the tap length. Otherwise, the temporary tap length is increased by one size and the setting and evaluation of the temporary interpolation reference pixel group is performed again. It is to be noted that the setting of the interpolation reference pixel group may be iterated while the temporary tap length is increased until the tap length is determined, or a maximum value may be set for the tap length and the maximum value may be determined as the tap length if the temporary tap length becomes greater than the maximum value. Furthermore, possible tap lengths may be continuous or discrete. For example, when the possible tap lengths are 1, 2, 4, and 6, implementation in which only a tap length in which the number of interpolation reference pixels are symmetrical with respect to the pixel position of the interpolation target is used other than the tap length of 1 is also preferable.

Next, a method for setting the interpolation reference pixel group as an arbitrary set of pixels will be described. First, a set of pixels within a predetermined range around the point qₚᵢₓ on the reference picture is set as a temporary interpolation reference picture group. Next, each pixel of the temporary interpolation reference picture group is checked to determine whether to adopt each pixel as an interpolation reference pixel. That is, when the pixel to be checked is denoted as p, the pixel p is excluded from interpolation reference pixels if the difference between the reference picture depth information rdₚ for the pixel p and dₚᵢₓ exceeds a threshold value and the pixel p is adopted as an interpolation reference pixel if the difference is less than or equal to the threshold value. A predetermined value may be used as the threshold value, or an average or a median of the differences between the depth information for pixels of the temporary interpolation reference picture group and dₚᵢₓ or a value determined based thereon may be used as the threshold value. In addition, there is also a method for adopting, as interpolation reference pixels, a predetermined number of pixels in ascending order of the differences between the reference picture depth information rdₚ for the pixel p and dₚᵢₓ. It is also possible to use these conditions in combination.

It is to be noted that when the interpolation reference pixel group is set, the two methods described above may be combined. For example, implementation in which an arbitrary set of pixels is generated by determining the tap length and then narrowing down the interpolation reference pixels and implementation in which formation of an arbitrary set of pixels is iterated while the tap length is increased until the number of the interpolation reference pixels reaches a separately determined number are preferable.

In addition, instead of comparing the depth information as described above, comparison of certain common information converted from the depth information may be performed. For example, a method for performing comparison of a distance from the camera capturing the reference picture or the camera capturing the encoding target picture to the object for the pixel which is converted from the depth information rdₚ and a method for performing comparison of coordinate values for an arbitrary axis which is not parallel to the camera picture which are converted from the depth information rdₚ or a disparity for an arbitrary pair of cameras which is converted from the depth information rdₚ are preferable. Furthermore, a method for obtaining three-dimensional points corresponding to the pixels from the depth information and performing evaluation using the distance between the three-dimensional points is also preferable. In this case, it is necessary to set a three-dimensional point corresponding to dₚᵢₓ as a three-dimensional point for the pixel pix and calculate a three-dimensional point for the pixel p using the depth information rdₚ.

Next, when the interpolation reference pixel group is determined, the pixel interpolating unit 1102 interpolates a pixel value for the correspondence point qₚᵢₓ on the reference picture for the pixel pix and sets it as the pixel value of the pixel pix of the disparity compensated picture (step S204). Any scheme may be used for the interpolation process as long as it is a method for determining the pixel value of the interpolation target position qₚᵢₓ using the pixel values of the reference picture in the interpolation reference pixel group. For example, there is a method for determining a pixel value of the interpolation target position qₚᵢₓ as a weighted average of the pixel values of the interpolation reference pixels. In this case, weights may be determined based on the distances between the interpolation reference pixels and the interpolation target position qₚᵢₓ. It is to be noted that a larger weight may be given when the distance is closer, and weights depending upon a distance generated by assuming the smoothness of a change in a fixed section, which is employed in a Bicubic method, a Lanczos method, or the like may be used. In addition, interpolation may be performed by estimating a model (function) for pixel values by using the interpolation reference pixels as samples and determining the pixel value of the interpolation target position qₚᵢₓ in accordance with the model.

In addition, when the interpolation reference pixel is determined as the tap length, implementation in which interpolation is performed using an interpolation filter predefined for each tap length is also preferable. For example, nearest neighbor interpolation (0-order interpolation) may be performed when the tap length is 1, interpolation may be performed using a bilinear filter when the tap length is 2, interpolation may be performed using a Bicubic filter when the tap length is 4, and interpolation may be performed using a Lanczos-3 filter or an AVC 6-tap filter when the tap length is 6.

There is also a method for setting pixels on the reference picture that are present at a fixed tap length, that is, a fixed distance, from the correspondence point as the interpolation target pixels and setting for each pixel to be interpolated a filter coefficient for each interpolation reference pixel using the reference picture depth information and the encoding target picture depth information in the generation of the disparity compensated picture. FIG. 5 is a diagram illustrating a modified example of a configuration of the disparity compensated picture generating unit 110 in this case, which generates a disparity compensated picture. The disparity compensated picture generating unit 110 illustrated in FIG. 5 includes a filter coefficient setting unit 1103 and a pixel interpolating unit 1104. The filter coefficient setting unit 1103 determines filter coefficients to be used when the pixel value of the correspondence point is interpolated for pixels of the reference picture that are present at a predetermined distance from the correspondence point set by the correspondence point setting unit 109. The pixel interpolating unit 1104 interpolates the pixel value at the position of the correspondence point using the set filter coefficients and the reference picture.

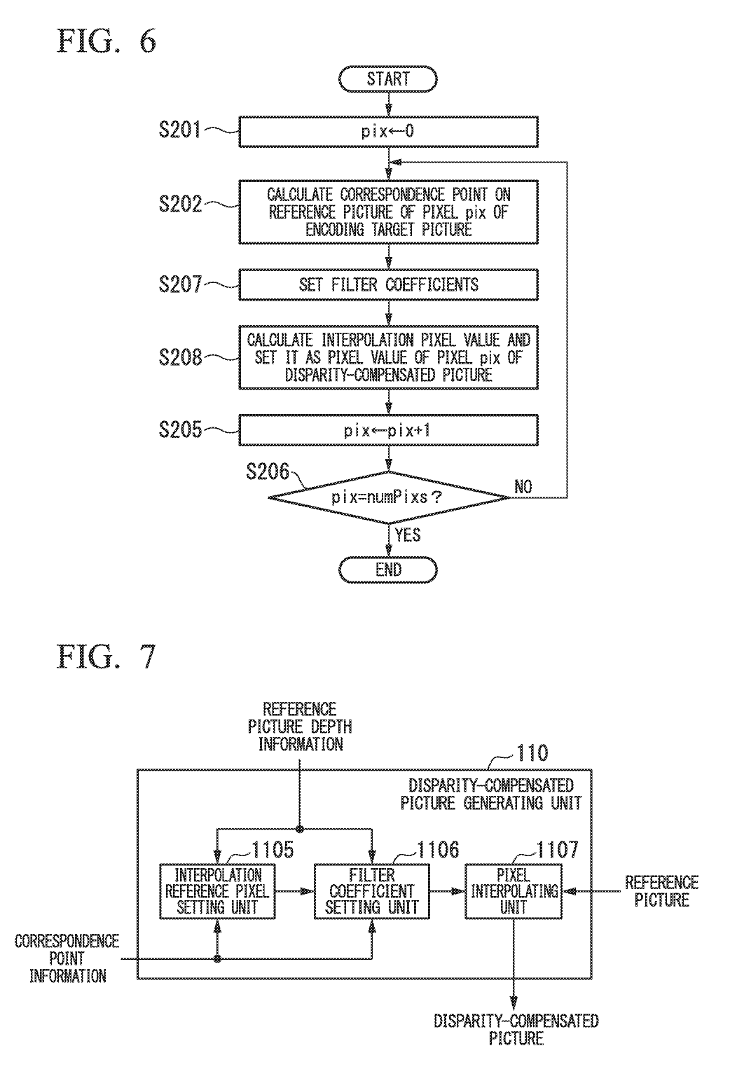

FIG. 6 is a flowchart illustrating an operation of disparity compensated picture processing (step S103) performed by the correspondence point setting unit 109 and the disparity compensated picture generating unit 110 illustrated in FIG. 5. The processing operation illustrated in FIG. 6 is an operation of generating a disparity compensated picture while adaptively determining filter coefficients and it generates the disparity compensated picture by iterating the process for every pixel on the entire encoding target picture. In FIG. 6, the processes that are the same as the processes illustrated in FIG. 4 are assigned the same reference signs. First, when a pixel index is denoted as pix and the total number of pixels in the picture is denoted as numPixs, the disparity compensated picture is generated by initializing pix to 0 (step S201) and then iterating the following process (steps S202, S207, and S208) until pix reaches numPixs (step S206) while pix is incremented by 1 (step S205).

As in the above-described case, the process may be iterated for every region having a predetermined size instead of every pixel, or the disparity compensated picture may be generated for a region having a predetermined size instead of the entire encoding target picture. In addition, the disparity compensated picture may be generated for a region having the same or another predetermined size by combining both of them and iterating the process for every region having the predetermined size. Its processing flow corresponds to a processing flow obtained by replacing the pixel with a “block to be iteratively processed” and replacing the encoding target picture is replaced with a “target region in which the disparity compensated picture is generated” in the processing flow illustrated in FIG. 6.

In the process to be performed for every pixel, first, the correspondence point setting unit 109 obtains a correspondence point on the reference picture for a pixel pix using processing target picture depth information dₚᵢₓ for the pixel pix (step S202). This process is the same as that described above. When the correspondence point qₚᵢₓ on the reference picture for the pixel pix is obtained, the filter coefficient setting unit 1103 then determines filter coefficients to be used when a pixel value of the correspondence point is interpolated and generated for each of interpolation reference pixels that are pixels present within a range of a predetermined distance from the correspondence point on the reference picture using the reference picture depth information and the processing target picture depth information dₚᵢₓ for the pixel pix (step S207). It is to be noted that when the correspondence point on the reference picture is present at an integer pixel position, the filter coefficient for the interpolation reference pixel at the integer pixel position represented by the correspondence point is set to 1 and filter coefficients for the other interpolation reference pixels are set to 0.

The filter coefficient for a certain interpolation reference pixel is determined using the reference depth information rdₚ for the interpolation reference pixel p. Although various methods can be used for a specific determination method, any method may be used as long as it is possible to use the same technique as that of the decoding end. For example, rdₚ may be compared with dₚᵢₓ and the filter coefficient may be determined so that a weight decreases as the difference therebetween increases. As an example of the filter coefficient based on the difference between rdₚ and dₚᵢₓ there is a method for simply using a value proportional to the absolute value of the difference or a method for determining the filter coefficient using a Gaussian function as in the following Equation 5. Here, α and β are parameters for adjusting the strength of a filter and e is Napier's constant.

### [Equation 5]

$${w}_{p} = α \cdot {e}^{\frac{- {( {rd}_{p} - {d}_{pix} )}^{2}}{2 {β}^{2}}} \qquad ( Equation 5 )$$

In addition, implementation in which a filter coefficient in which a weight is smaller when the distance between p and qₚᵢₓ is larger is determined is also preferable as well as the difference between rdₚ and dₚᵢₓ. For example, the filter coefficient may be determined using the Gaussian function as in the following Equation 6. Here, γ is a parameter for adjusting the strength of an influence of the distance between p and qₚᵢₓ.

### [Equation 6]

$${w}_{p} = α \cdot {e}^{\frac{- {( {rd}_{p} - {d}_{pix} )}^{2}}{2 {β}^{2}}} \cdot {e}^{\frac{- {( p - {q}_{pix} )}^{2}}{2 {γ}^{2}}} \qquad ( Equation 6 )$$

It is to be noted that comparison of certain common information converted from the depth information may be performed instead of directly comparing the depth information as described above. For example, a method for performing comparison of the distance from the camera capturing the reference picture or the camera capturing the encoding target picture to the object for the pixel which is converted from the depth information rdₚ and a method for performing comparison of coordinate values for an arbitrary axis which is not parallel to the camera picture which are converted from the depth information rdₚ or a disparity for an arbitrary pair of cameras which is converted from the depth information rdₚ are preferable. Furthermore, a method for obtaining three-dimensional points corresponding to the pixels from the depth information and performing evaluation using the distance between the three-dimensional points is also preferable. In this case, it is necessary to set a three-dimensional point corresponding to dₚᵢₓ as a three-dimensional point for the pixel pix and calculate a three-dimensional point for the pixel p using the depth information rdₚ.

Next, when the filter coefficients are determined, the pixel interpolating unit 1104 interpolates a pixel value for the correspondence point qₚᵢₓ on the reference picture for the pixel pix and sets it as the pixel value of the disparity compensated picture in the pixel pix (step S208). The process here is given in the following Equation 7. It is to be noted that S denotes a set of interpolation reference pixels, DCPₚᵢₓ denotes an interpolated pixel value, and Rₚ denotes a pixel value of the reference picture for the pixel p.

### [Equation 7]

$${DCP}_{pix} = \frac{1}{W} {\sum }_{p ∈ S}^{ } {w}_{p} \cdot {R}_{p} \\ W = {\sum }_{p ∈ S}^{ } {w}_{p} \qquad ( Equations 7 )$$

In the generation of the disparity compensated picture, there is also a method for setting for each pixel to be interpolated both the selection of the interpolation reference pixels and the determination of the filter coefficients for the interpolation reference pixels using the reference picture depth information and the encoding target picture depth information by combining the two methods described above. FIG. 7 is a diagram illustrating a modified example of a configuration of the disparity compensated picture generating unit 110, which generates a disparity compensated picture. The disparity compensated picture generating unit 110 illustrated in FIG. 7 includes an interpolation reference pixel setting unit 1105, a filter coefficient setting unit 1106, and a pixel interpolating unit 1107. The interpolation reference pixel setting unit 1105 determines a set of interpolation reference pixels which are pixels of a reference picture to be used to interpolate a pixel value of a correspondence point set by the correspondence point setting unit 109. The filter coefficient setting unit 1106 determines filter coefficients to be used when the pixel value of the correspondence point is interpolated for the interpolation reference pixels set by the interpolation reference pixel setting unit 1105. The pixel interpolating unit 1107 interpolates the pixel value at the position of the correspondence point using the set interpolation reference pixels and filter coefficients.

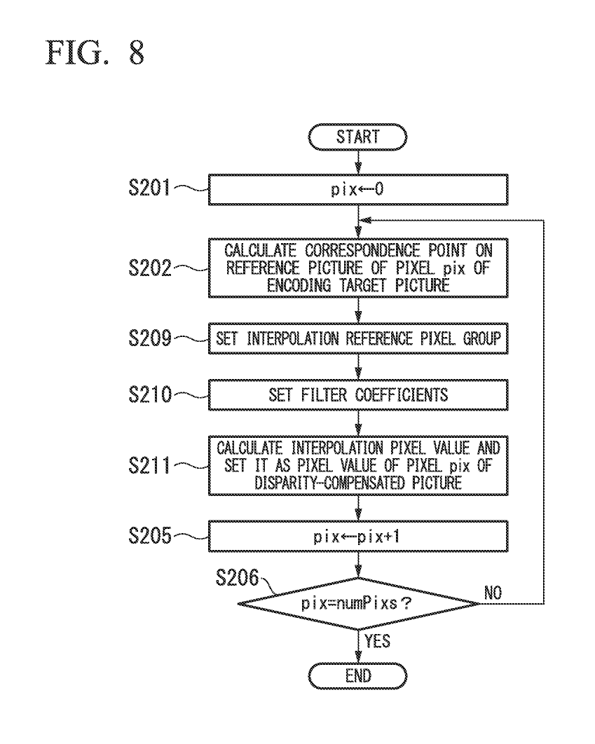

FIG. 8 is a flowchart illustrating an operation of disparity compensated picture processing (step S103) performed by the correspondence point setting unit 109 and the disparity compensated picture generating unit 110 illustrated in FIG. 7. The processing operation illustrated in FIG. 8 is an operation of generating a disparity compensated picture while adaptively determining filter coefficients and it generates the disparity compensated picture by iterating the process for every pixel on the entire encoding target picture. In FIG. 8, the processes that are the same as the processes illustrated in FIG. 4 are assigned the same reference signs. First, when a pixel index is denoted as pix and the total number of pixels in the picture is denoted as numPixs, the disparity compensated picture is generated by initializing pix to 0 (step S201) and then iterating the following process (steps S202 and S209 to S211) until pix reaches numPixs (step S206) while pix is incremented by 1 (step S205).

As in the above-described case, the process may be iterated for every region having a predetermined size instead of every pixel, or the disparity compensated picture may be generated for a region having a predetermined size instead of the entire encoding target picture. In addition, the disparity compensated picture may be generated for a region having the same or another predetermined size by combining both of them and iterating the process for every region having the predetermined size. Its processing flow corresponds to a processing flow obtained by replacing the pixel with a “block to be iteratively processed” and replacing the encoding target picture with a “target region in which the disparity compensated picture is generated” in the processing flow illustrated in FIG. 8.

In the process to be performed for every pixel, first, the correspondence point setting unit 109 obtains a correspondence point on the reference pixel for a pixel pix using processing target picture depth information dₚᵢₓ for the pixel pix (step S202). The process here is the same as that of the above-described case. When the correspondence point qₚᵢₓ on the reference picture for the pixel pix is obtained, the interpolation reference pixel setting unit 1105 then determines a set (interpolation reference pixel group) of interpolation reference pixels for interpolating and generating a pixel value for the correspondence point on the reference picture using the reference picture depth information and the processing target picture information dₚᵢₓ for the pixel pix (step S209). The process here is the same as the above-described step S203.

Next, when the set of interpolation reference pixels is determined, the filter coefficient setting unit 1106 determines filter coefficients to be used when a pixel value of the correspondence point is interpolated and generated for each of the determined interpolation reference pixels using the reference picture depth information and the processing target picture depth information dₚᵢₓ for the pixel pix (step S210). The process here is the same as the above-described step S207 except that filter coefficients are determined for a given set of interpolation reference pixels.

Next, when the filter coefficients are determined, the pixel interpolating unit 1107 interpolates a pixel value for the correspondence point qₚᵢₓ on the reference picture for the pixel pix and sets it as the pixel value of the disparity compensated picture in the pixel pix (step S211). The process here is the same as the above-described step S208 except that the set of interpolation reference pixels determined in step S209 is used. That is, the set of interpolation reference pixels determined in step S209 is used as the set S of interpolation reference pixels in the above-described Equation 7.

### Second Embodiment

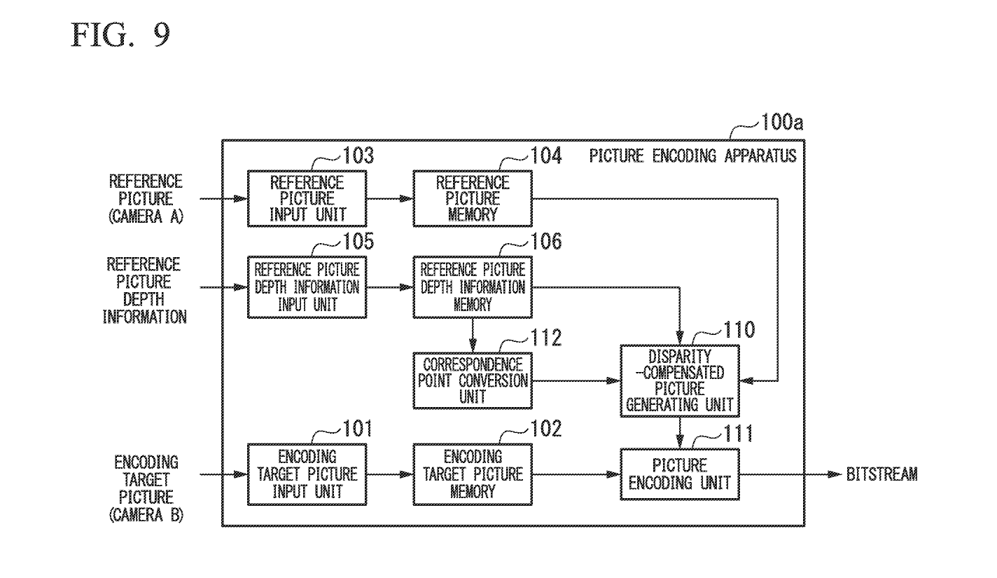

Next, a second embodiment of the present invention will be described. Although two types of information including the processing target picture depth information and the reference picture depth information are used in the above-described picture encoding apparatus 100 illustrated in FIG. 1, only the reference picture depth information may be used. FIG. 9 is a diagram illustrating a configuration example of a picture encoding apparatus 100a when only the reference picture depth information is used. The picture encoding apparatus 100a illustrated in FIG. 9 is different from the picture encoding apparatus 100 illustrated in FIG. 1 in that the processing target picture depth information input unit 107 and the processing target picture depth information memory 108 are not provided and a correspondence point conversion unit 112 is provided instead of the correspondence point setting unit 109. It is to be noted that the correspondence point conversion unit 112 sets a correspondence point on the reference picture for an integer pixel of the encoding target picture using the reference picture depth information.

A process to be executed by the picture encoding apparatus 100a is the same as the process to be executed by the picture encoding apparatus 100 except for the following two points. First, a first difference is that, while the reference picture, the reference picture depth information, and the processing target picture depth information are input in the picture encoding apparatus 100 in step S102 of the flowchart of FIG. 2, only the reference picture and the reference picture depth information are input in the picture encoding apparatus 100a. A second difference is that the disparity compensated picture generating process (step S103) is performed by the correspondence point conversion unit 112 and the disparity compensated picture generating unit 110 and its content is different therefrom.

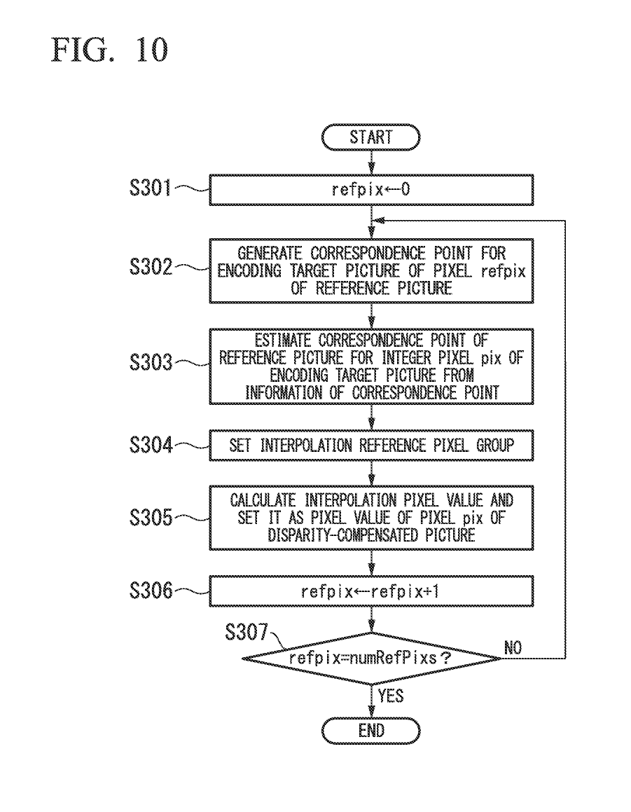

A process of generating a disparity compensated picture in the picture encoding apparatus 100a will be described in detail. It is to be noted that the configuration of the disparity compensated picture generating unit 110 illustrated in FIG. 9 is the same as that of the picture encoding apparatus 100, and, as described above, a set of interpolation reference pixels may be set, filter coefficients may be set, and both of them may be set. Here, the case in which the set of interpolation reference pictures is set will be described. FIG. 10 is a flowchart illustrating the operation of the disparity compensated picture processing performed by the picture encoding apparatus 100a illustrated in FIG. 9. In the processing operation illustrated in FIG. 10, a disparity compensated picture is generated by iterating the process for every pixel on the entire reference picture. First, when a pixel index is denoted as refpix and the total number of pixels in the reference picture is denoted as numRefPixs, the disparity compensated picture is generated by initializing refpix to 0 (step S301) and then iterating the following process (steps S302 to S305) until refpix reaches numRefPixs (step S307) while refpix is incremented by 1 (step S306).

Here, the process may be iterated for every region having a predetermined size instead of every pixel, or the disparity compensated picture may be generated using a reference picture for a predetermined region instead of the entire reference picture. In addition, the disparity compensated picture using a reference picture of the same or another predetermined region may be generated by combining both of them and iterating the process for every region having the predetermined size. Its processing flow corresponds to a processing flow obtained by replacing the pixel with a “block to be iteratively processed” and replacing the reference picture with a “region used for generation of the disparity compensated picture” in the processing flow illustrated in FIG. 10. Implementation in which a unit in which the process is iterated is matched with a size corresponding to a unit in which the reference picture depth information is given and implementation in which target regions in which the disparity compensated picture is generated is matched with regions of the reference picture corresponding to regions when the encoding target picture are divided into the regions and predictive encoding is performed are also preferable.

In the process to be performed for every pixel, first, the correspondence point conversion unit 112 obtains a correspondence point q_{refpix} on the processing target picture for the pixel refpix using reference picture depth information d_{refpix} for the pixel refpix (step S302). The process here is the same as the above-described step S202 except that the reference picture and the processing target picture are interchanged. When the correspondence point g_{refpix} on the processing target picture for the pixel refpix is obtained, the correspondence point qₚᵢₓ on the reference picture for the integer pixel pix of the processing target picture is estimated from the correspondence relationship (step S303). Any method may be used for this method and, for example, the method disclosed in Patent Document 1 may be used.

Next, when the correspondence point qₚᵢₓ on the reference picture for the integer pixel pix of the processing target picture is obtained, the depth information for the pixel pix is designated as rd_{refpix} and a set (interpolation reference pixel group) of interpolation reference pixels for interpolating and generating a pixel value for the correspondence point on the reference picture is determined using the reference picture depth information (step S304). The process here is the same as the above-described step S203.

Next, when the interpolation reference pixel group is determined, a pixel value for the correspondence point qₚᵢₓ on the reference picture for the pixel pix is interpolated and it is set as the pixel value of the pixel pix of the disparity compensated picture (step S305). The process here is the same as the above-described step S204.

### Third Embodiment

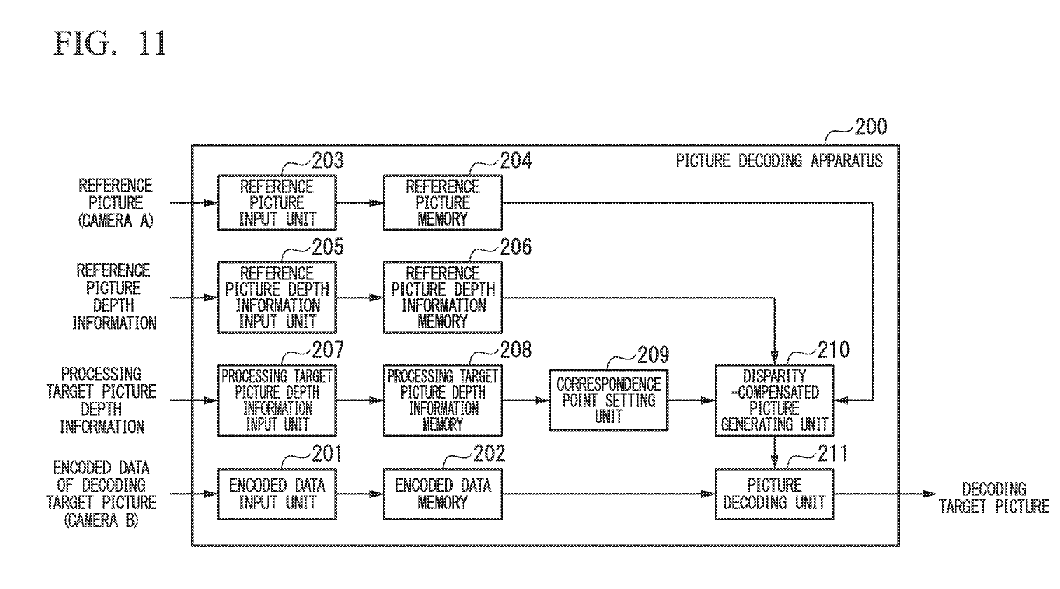

Next, a third embodiment of the present invention will be described. FIG. 11 is a diagram illustrating a configuration example of a picture decoding apparatus in accordance with the third embodiment of the present invention. As illustrated in FIG. 11, a picture decoding apparatus 200 includes an encoded data input unit 201, an encoded data memory 202, a reference picture input unit 203, a reference picture memory 204, a reference picture depth information input unit 205, a reference picture depth information memory 206, a processing target picture depth information input unit, 207, a processing target picture depth information memory 208, a correspondence point setting unit 209, a disparity compensated picture generating unit 210, and a picture decoding unit 211.

The encoded data input unit 201 inputs encoded data of a picture serving as a decoding target. Hereinafter, the picture serving as the decoding target is referred to as a decoding target picture. Here, the decoding target picture refers to a picture of the camera B. The encoded data memory 202 stores the input encoded data. The reference picture input unit 203 inputs a picture serving as a reference picture when a disparity compensated picture is generated. Here, a picture of the camera A is input. The reference picture memory 204 stores the input reference picture. The reference picture depth information input unit 205 inputs reference picture depth information. The reference picture depth information memory 206 stores the input reference picture depth information. The processing target picture depth information input unit 207 inputs depth information for the decoding target picture. Hereinafter, the depth information for the decoding target picture is referred to as processing target picture depth information. The processing target picture depth information memory 208 stores the input processing target picture depth information.

The correspondence point setting unit 209 sets a correspondence point on the reference picture for each pixel of the decoding target picture using the processing target picture depth information. The disparity compensated picture generating unit 210 generates the disparity compensated picture using the reference picture and information of the correspondence point. The picture decoding unit 211 decodes the decoding target picture from the encoded data using the disparity compensated picture as a predicted picture.

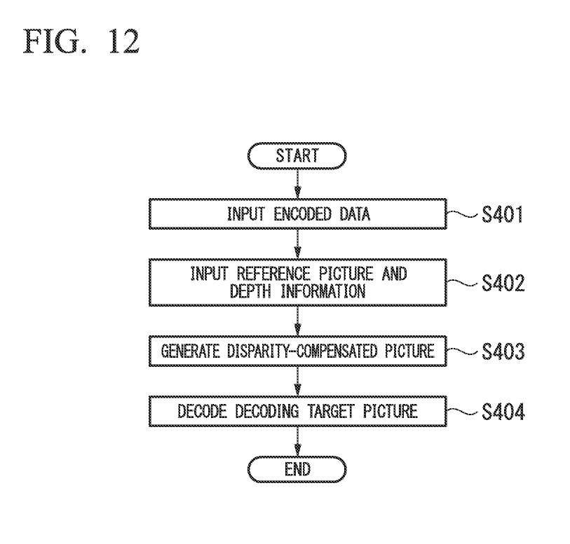

Next, a processing operation of the picture decoding apparatus 200 illustrated in FIG. 11 will be described with reference to FIG. 12. FIG. 12 is a flowchart illustrating the processing operation of the picture decoding apparatus 200 illustrated in FIG. 11. First, the encoded data input unit 201 inputs encoded data (a decoding target picture) and stores it in the encoded data memory 202 (step S401). In parallel therewith, the reference picture input unit 203 inputs a reference picture and stores it in the reference picture memory 204. In addition, the reference picture depth information input unit 205 inputs reference picture depth information and stores it in the reference picture depth information memory 206. Furthermore, the processing target picture depth information input unit 207 inputs processing target picture depth information and stores it in the processing target picture depth information memory 208 (step S402).

It is to be noted that the reference picture, the reference picture depth information, and the processing target picture depth information input in step S402 are assumed to be the same as information used by the encoding end. This is because the occurrence of coding noise such as a drift is suppressed by using completely the same information as that used by the encoding apparatus. However, if the occurrence of such coding noise is allowed, information different from that used at the time of encoding may be input. With respect to the depth information, depth information generated from depth information decoded for another camera, depth information estimated by applying stereo matching or the like to a multiview picture decoded for a plurality of cameras, or the like may also be used instead of separately decoded depth information.

Next, when the input has been completed, the correspondence point setting unit 209 generates a correspondence point or a correspondence block on the reference picture for each pixel or predetermined block of the decoding target picture using the reference picture, the reference picture depth information, and the processing target picture depth information. In parallel therewith, the disparity compensated picture generating unit 210 generates a disparity compensated picture (step S403). The process here is the same as step S103 illustrated in FIG. 2 except for differences in terms of encoding and decoding such as an encoding target picture and a decoding target picture.

Next, when the disparity compensated picture has been obtained, the picture decoding unit 211 decodes the decoding target picture from the encoded data using the disparity compensated picture as a predicted picture (step S404). A decoding target picture obtained by the decoding becomes an output of the picture decoding apparatus 200. It is to be noted that any method may be used in decoding as long as encoded data (a bitstream) can be correctly decoded. In general, a method corresponding to that used at the time of encoding is used.

When encoding is performed in accordance with general moving picture coding or picture coding such as MPEG-2, H.264, or JPEG, decoding is performed by dividing a picture into blocks each having a predetermined size, performing entropy decoding, inverse binarization, inverse quantization, and the like for every block, obtaining a predictive residual signal by applying inverse frequency conversion such as an inverse discrete cosine transform (IDCT) for every block, adding a predicted picture to the predictive residual signal, and clipping an obtained result in the range of a pixel value.

It is to be noted that when the decoding process is performed for each block, the decoding target picture may be decoded by iterating the disparity compensated picture generating process (step S403) and the decoding target picture decoding process (step S404) alternately for every block.

### Fourth Embodiment

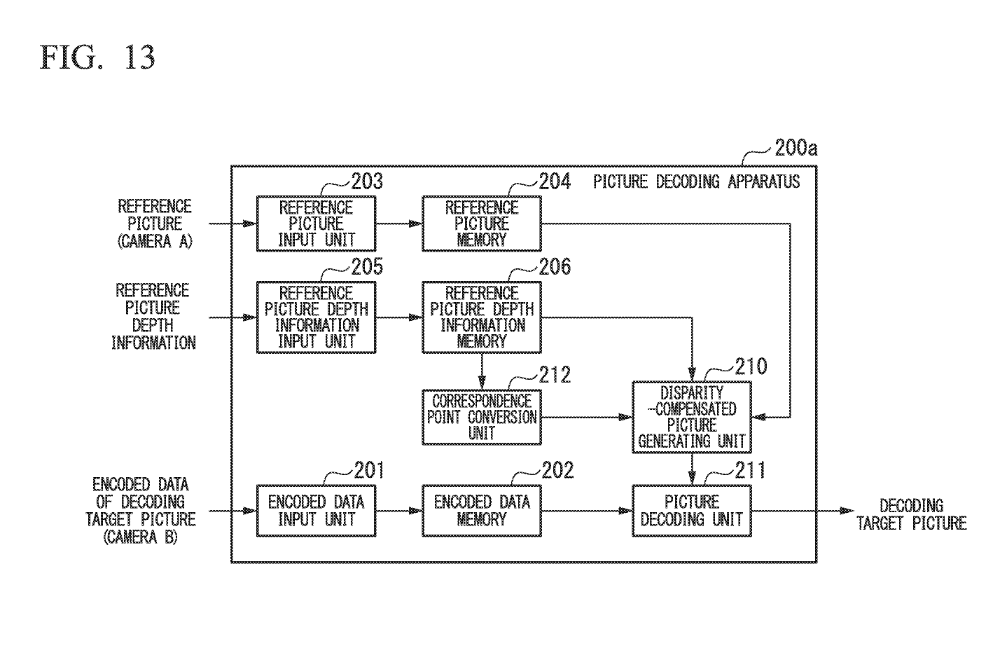

Next, a fourth embodiment of the present invention will be described. Although two types of information including the processing target picture depth information and the reference picture depth information are used in the picture decoding apparatus 200 illustrated in FIG. 11, only the reference picture depth information may be used. FIG. 13 is a diagram illustrating a configuration example of a picture decoding apparatus 200a when only the reference picture depth information is used. The picture decoding apparatus 200a illustrated in FIG. 13 is different from the picture decoding apparatus 200 illustrated in FIG. 11 in that the processing target picture depth information input unit 207 and the processing target picture depth information memory 208 are not provided and a correspondence point conversion unit 212 is provided instead of the correspondence point setting unit 209. It is to be noted that the correspondence point conversion unit 212 sets a correspondence point on the reference picture for an integer pixel of the decoding target picture using the reference picture depth information.

A process to be executed by the picture decoding apparatus 200a is the same as the process to be executed by the picture decoding apparatus 200 except for the following two points. First, a first difference is that, although the reference picture, the reference picture depth information, and the processing target picture depth information are input in the picture decoding apparatus 200 in step S402 illustrated in FIG. 12, only the reference picture and the reference picture depth information are input in the picture decoding apparatus 200a. A second difference is that the disparity compensated picture generating process (step S403) is performed by the correspondence point conversion unit 212 and the disparity compensated picture generating unit 210 and its content is different therefrom. The disparity compensated picture generating process in the picture decoding apparatus 200a is the same as the process described with reference to FIG. 10.

Although a process of encoding and decoding all pixels of one frame has been described in the above description, coding may be performed by applying the process of the embodiments of the present invention for only some pixels and using intra-frame predictive coding, motion-compensated predictive coding, or the like employed in H.264/AVC or the like for the other pixels. In this case, it is necessary to encode and decode information representing a method used for encoding for each pixel. In addition, coding may be performed using different prediction schemes on a block-by-block basis rather than on a pixel-by-pixel basis.

In addition, although a process of encoding and decoding one frame has been described in the above description, it is also possible to apply the embodiments of the present invention to moving picture coding by iterating the process for a plurality of frames. In addition, it is possible to apply the embodiments of the present invention to only some frames or blocks of moving pictures.

Although the picture encoding apparatus and the picture decoding apparatus have been mainly described in the above description, it is possible to achieve a picture encoding method and a picture decoding method of the present invention by using steps corresponding to the operations of the units of the picture encoding apparatus and the picture decoding apparatus.

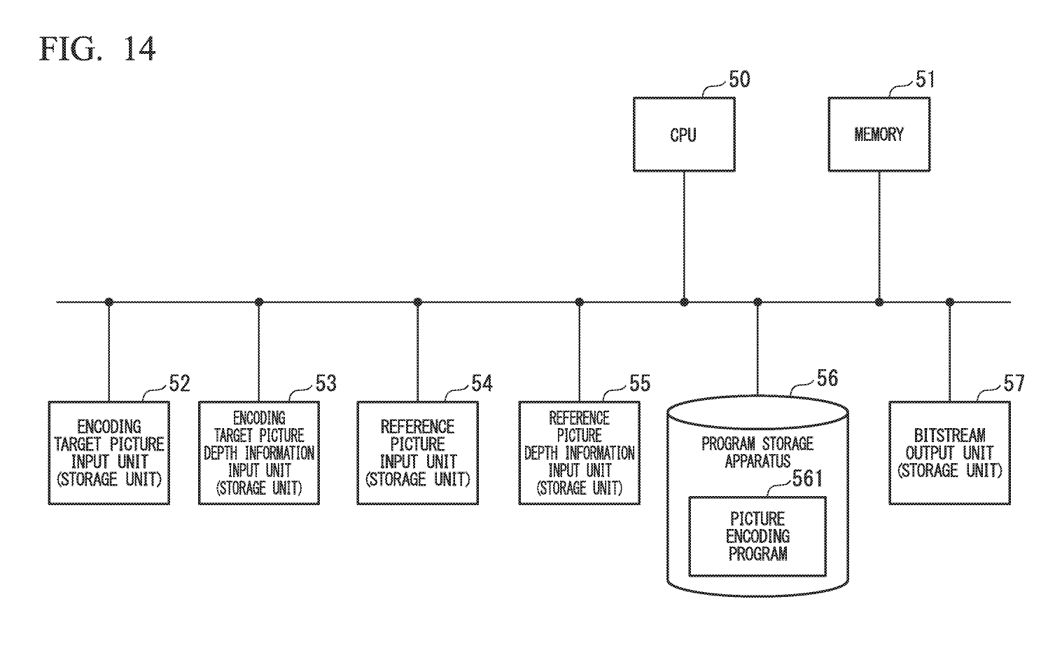

FIG. 14 illustrates a configuration example of hardware when the picture encoding apparatus is configured by a computer and a software program. The system illustrated in FIG. 14 is configured so that a central processing unit (CPU) 50 which executes the program, a memory 51 such as a random access memory (RAM) storing the program and data to be accessed by the CPU 50, an encoding target picture input unit 52 (which may be a storage unit which stores a picture signal by a disk apparatus or the like) which inputs an encoding target picture signal from a camera or the like, an encoding target picture depth information input unit 53 (which may be a storage unit which stores depth information by the disk apparatus or the like) which inputs depth information for an encoding target picture from a depth camera or the like, a reference picture input unit 54 (which may be a storage unit which stores a picture signal by the disk apparatus or the like) which inputs a reference target picture signal from a camera or the like, a reference picture depth information input unit 55 (which may be a storage unit which store depth information by the disk apparatus or the like) which inputs depth information for the reference picture from a depth camera or the like, a program storage apparatus 56 which stores a picture encoding program 561 which is a software program for causing the CPU 50 to execute a picture encoding process described as the first or second embodiment, and a bitstream output unit 57 (which may be a storage unit which stores multiplexed encoded data by the disk apparatus or the like) which outputs encoded data generated by executing the picture encoding program 561 loaded by the CPU 50 to the memory 51, for example, via a network, are connected by a bus.

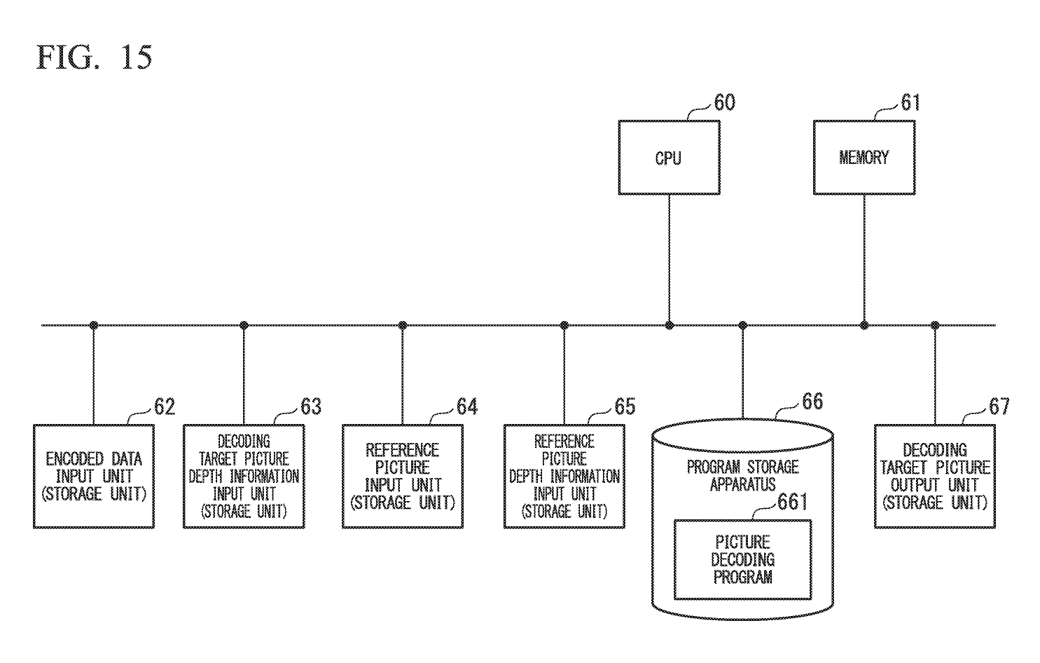

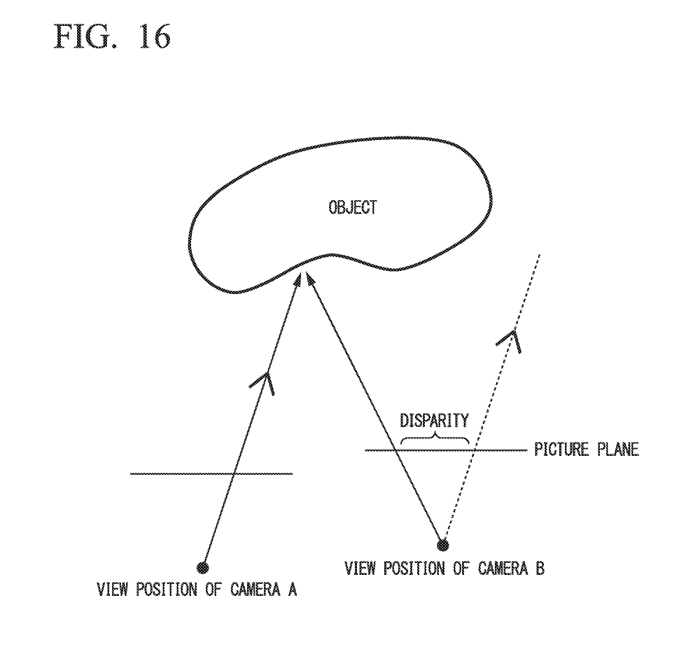

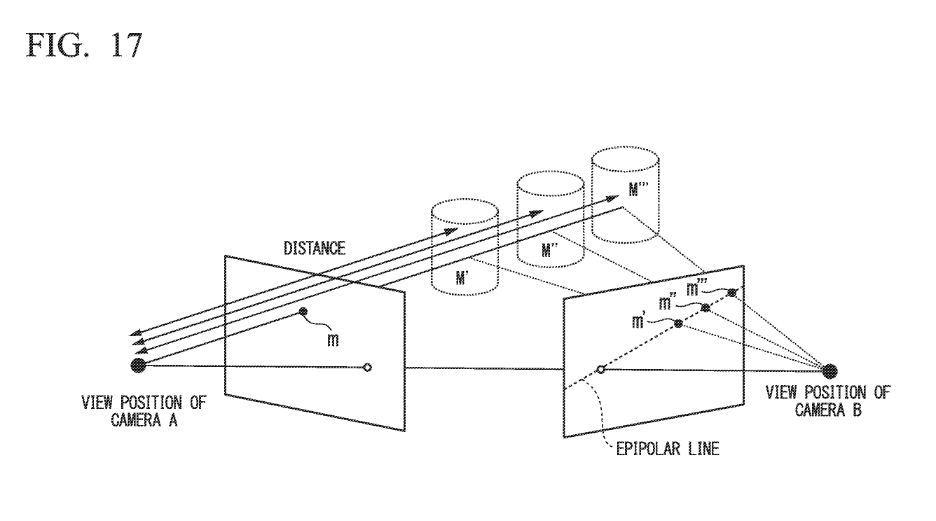

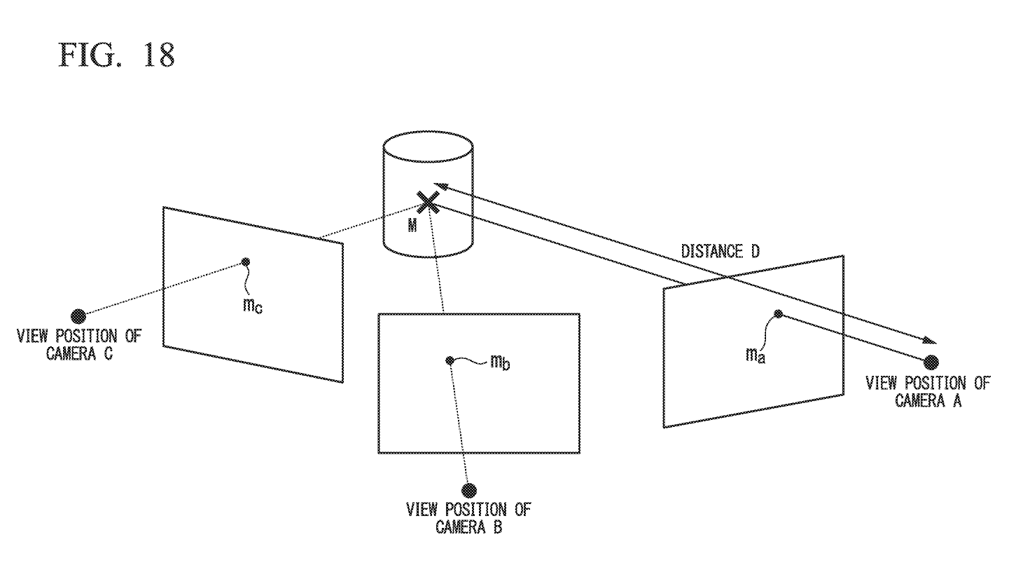

FIG. 15 illustrates a configuration example of hardware when the picture decoding apparatus is configured by a computer and a software program. The system illustrated in FIG. 15 is configured so that a CPU 60 which executes the program, a memory 61 such as a RAM storing the program and data to be accessed by the CPU 60, an encoded data input unit 62 (which may be a storage unit which stores a picture signal by a disk apparatus or the like) which inputs encoded data encoded by the picture encoding apparatus in accordance with the present technique, a decoding target picture depth information input unit 63 (which may be a storage unit which stores depth information by the disk apparatus or the like) which inputs depth information for a decoding target picture from a depth camera or the like, a reference picture input unit 64 (which may be a storage unit which stores a picture signal by the disk apparatus or the like) which inputs a reference target picture signal from a camera or the like, a reference picture depth information input unit 65 (which may be a storage unit which stores depth information by the disk apparatus or the like) which inputs depth information for a reference picture from the depth camera or the like, a program storage apparatus 66 which stores a picture decoding program 661 which is a software program for causing the CPU 60 to execute a picture decoding process described as the third or fourth embodiment, and a decoding target picture output unit 67 (which may be a storage unit which stores a picture signal by the disk apparatus or the like) which outputs a decoding target picture obtained by performing decoding on the encoded data to a reproduction apparatus or the like by executing the picture decoding program 661 loaded by the CPU 60 to the memory 61 are connected by a bus.

In addition, the picture encoding process and the picture decoding process may be performed by recording a program for achieving the functions of the processing units in the picture encoding apparatuses illustrated in FIGS. 1 and 9 and the picture decoding apparatuses illustrated in FIGS. 11 and 13 on a computer-readable recording medium and causing a computer system to read and execute the program recorded on the recording medium. It is to be noted that the “computer system” used here includes an operating system (OS) and hardware such as peripheral devices. In addition, the “computer system” includes a World Wide Web (WWW) system which is provided with a homepage providing environment (or displaying environment). In addition, the “computer-readable recording medium” refers to a storage apparatus, including a portable medium such as a flexible disk, a magneto-optical disc, a read only memory (ROM), or a compact disc (CD)-ROM, and a hard disk embedded in the computer system. Furthermore, the “computer-readable recording medium” includes a medium that holds a program for a constant period of time, such as a volatile memory (RAM) inside a computer system serving as a server or a client when the program is transmitted via a network such as the Internet or a communication circuit such as a telephone circuit.

In addition, the above program may be transmitted from a computer system storing the program in a storage apparatus or the like via a transmission medium or transmission waves in the transmission medium to another computer system. Here, the “transmission medium” for transmitting the program refers to a medium having a function of transmitting information, such as a network (communication network) like the Internet or a communication circuit (communication line) like a telephone circuit. In addition, the above program may be a program for achieving some of the above-described functions. Furthermore, the above program may be a program, i.e., a so-called differential file (differential program), capable of achieving the above-described functions in combination with a program already recorded on the computer system.

While the embodiments of the present invention have been described above with reference to the drawings, it is apparent that the above embodiments are exemplary of the present invention and the present invention is not limited to the above embodiments. Accordingly, additions, omissions, substitutions, and other modifications of constituent elements may be made without departing from the technical idea and the scope of the present invention.

### INDUSTRIAL APPLICABILITY

The present invention is applicable for essential use in achieving high coding efficiency when disparity-compensated prediction is performed on an encoding (decoding) target picture using depth information representing a three-dimensional position of an object in a reference picture.

### DESCRIPTION OF REFERENCE SIGNS

100, 100a Picture encoding apparatus
101 Encoding target picture input unit
102 Encoding target picture memory
103 Reference picture input unit
104 Reference picture memory
105 Reference picture depth information input unit
106 Reference picture depth information memory
107 Processing target picture depth information input unit
108 Processing target picture depth information memory
109 Correspondence point setting unit
110 Disparity compensated picture generating unit
111 Picture encoding unit
1103 Filter coefficient setting unit
1104 Pixel interpolating unit
1105 Interpolation reference pixel setting unit
1106 Filter coefficient setting unit
1107 Pixel interpolating unit
112 Correspondence point conversion unit
200, 200a Picture decoding apparatus
201 Encoded data input unit
202 Encoded data memory
203 Reference picture input unit
204 Reference picture memory
205 Reference picture depth information input unit
206 Reference picture depth information memory
207 Processing target picture depth information input unit
208 Processing target picture depth information memory
209 Correspondence point setting unit
210 Disparity compensated picture generating unit
211 Picture decoding unit
212 Correspondence point conversion unit

1. A picture encoding method for performing encoding while predicting a picture between a plurality of views using a reference picture encoded for a view different from a view of an encoding target picture and reference picture depth information which is depth information of an object in the reference picture when a multiview picture which includes pictures from the views is encoded, the method comprising:
a correspondence point setting step of setting a correspondence point on the reference picture for each pixel of the encoding target picture;
an object depth information setting step of setting object depth information which is depth information for a pixel at an integer pixel position on the encoding target picture indicated by the correspondence point;
an interpolation tap length determining step of determining a tap length for pixel interpolation using the reference picture depth information for a pixel at an integer pixel position or an integer pixel position around a fractional pixel position on the reference picture indicated by the correspondence point and the object depth information;
a pixel interpolating step of generating a pixel value at the integer pixel position or the fractional pixel position on the reference picture indicated by the correspondence point using an interpolation filter in accordance with the tap length; and
an inter-view picture predicting step of performing inter-view picture prediction by setting the pixel value generated in the pixel interpolating step as a predicted value of the pixel at the integer pixel position on the encoding target picture indicated by the correspondence point.

2. A picture encoding method for performing encoding while predicting a picture between a plurality of views using a reference picture encoded for a view different from a view of an encoding target picture and reference picture depth information which is depth information of an object in the reference picture when a multiview picture which includes pictures from the views is encoded, the method comprising:
a correspondence point setting step of setting a correspondence point on the reference picture for each pixel of the encoding target picture;
an object depth information setting step of setting object depth information which is depth information for a pixel at an integer pixel position on the encoding target picture indicated by the correspondence point;
an interpolation reference pixel setting step of setting pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information;
a pixel interpolating step of generating a pixel value at the integer pixel position or the fractional pixel position on the reference picture indicated by the correspondence point in accordance with a weighted sum of pixel values of the interpolation reference pixels; and
an inter-view picture predicting step of performing inter-view picture prediction by setting the pixel value generated in the pixel interpolating step as a predicted value of the pixel at the integer pixel position on the encoding target picture indicated by the correspondence point.

3. The picture encoding method according to claim 2, further comprising an interpolation coefficient determining step of determining interpolation coefficients for the interpolation reference pixels based on a difference between the reference picture depth information for the interpolation reference pixels and the object depth information for each of the interpolation reference pixels,
wherein the interpolation reference pixel setting step sets the pixel at the integer pixel position or the integer pixel position around the fractional pixel position on the reference picture indicated by the correspondence point as the interpolation reference pixels, and
the pixel interpolating step generates the pixel value at the integer pixel position or the fractional pixel position on the reference picture indicated by the correspondence point by obtaining the weighted sum of the pixel values of the interpolation reference pixels based on the interpolation coefficients.

4. The picture encoding method according to claim 3, further comprising an interpolation tap length determining step of determining a tap length for pixel interpolation using the reference picture depth information for the pixel at the integer pixel position or the integer pixel position around the fractional pixel position on the reference picture indicated by the correspondence point and the object depth information,
wherein the interpolation reference pixel setting step sets pixels present in a range of the tap length as the interpolation reference pixels.

5. The picture encoding method according to claim 3 or 4, wherein the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines the interpolation coefficient based on the difference if the magnitude of the difference is within the threshold value.

6. The picture encoding method according to claim 3 or 4, wherein the interpolation coefficient determining step determines an interpolation coefficient based on a difference between the reference picture depth information for one of the interpolation reference pixels and the object depth information and a distance between one of the interpolation reference pixels and an integer pixel or a fractional pixel on the reference picture indicated by the correspondence point.

7. The picture encoding method according to claim 3 or 4, wherein the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines an interpolation coefficient based on the difference and a distance between one of the interpolation reference pixels and an integer pixel or a fractional pixel on the reference picture indicated by the correspondence point if the magnitude of the difference is within the predetermined threshold value.

8. A picture decoding method for performing decoding while predicting a picture between views using a decoded reference picture and reference picture depth information which is depth information of an object in the reference picture when a decoding target picture of a multiview picture is decoded, the method comprising:
a correspondence point setting step of setting a correspondence point on the reference picture for each pixel of the decoding target picture;
an object depth information setting step of setting object depth information which is depth information for a pixel at an integer pixel position on the decoding target picture indicated by the correspondence point;
an interpolation tap length determining step of determining a tap length for pixel interpolation using the reference picture depth information for a pixel at an integer pixel position or an integer pixel position around a fractional pixel position on the reference picture indicated by the correspondence point and the object depth information;
a pixel interpolating step of generating a pixel value at the integer pixel position or the fractional pixel position on the reference picture indicated by the correspondence point using an interpolation filter in accordance with the tap length; and
an inter-view picture predicting step of performing inter-view picture prediction by setting the pixel value generated in the pixel interpolating step as a predicted value of the pixel at the integer pixel position on the decoding target picture indicated by the correspondence point.

9. A picture decoding method for performing decoding while predicting a picture between views using a decoded reference picture and reference picture depth information which is depth information of an object in the reference picture when a decoding target picture of a multiview picture is decoded, the method comprising:
a correspondence point setting step of setting a correspondence point on the reference picture for each pixel of the decoding target picture;
an object depth information setting step of setting object depth information which is depth information for a pixel at an integer pixel position on the decoding target picture indicated by the correspondence point;
an interpolation reference pixel setting step of setting pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information;
a pixel interpolating step of generating a pixel value at the integer pixel position or the fractional pixel position on the reference picture indicated by the correspondence point in accordance with a weighted sum of pixel values of the interpolation reference pixels; and
an inter-view picture predicting step of performing inter-view picture prediction by setting the pixel value generated in the pixel interpolating step as a predicted value of the pixel at the integer pixel position on the decoding target picture indicated by the correspondence point.

10. The picture decoding method according to claim 9, further comprising an interpolation coefficient determining step of determining interpolation coefficients for the interpolation reference pixels based on a difference between the reference pixel depth information for the interpolation reference pixels and the object depth information for each of the interpolation reference pixels,
wherein the interpolation reference pixel setting step sets the pixel at the integer pixel position or the integer pixel position around the fractional pixel position on the reference picture indicated by the correspondence point as the interpolation reference pixels, and
the pixel interpolating step generates the pixel value at the integer pixel position or the fractional pixel position on the reference picture indicated by the correspondence point by obtaining the weighted sum of the pixel values of the interpolation reference pixels based on the interpolation coefficients.

11. The picture decoding method according to claim 10, further comprising an interpolation tap length determining step of determining a tap length for pixel interpolation using the reference picture depth information for the pixel at the integer pixel position or the integer pixel position around the fractional pixel position on the reference picture indicated by the correspondence point and the object depth information,
wherein the interpolation reference pixel setting step sets pixels present in a range of the tap length as the interpolation reference pixels.

12. The picture decoding method according to claim 10 or 11, wherein the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines the interpolation coefficient based on the difference if the magnitude of the difference is within the threshold value.

13. The picture decoding method according to claim 10 or 11, wherein the interpolation coefficient determining step determines an interpolation coefficients based on a difference between the reference picture depth information for one of the interpolation reference pixels and the object depth information and a distance between one of the interpolation reference pixels and an integer pixel or a fractional pixel on the reference picture indicated by the correspondence point.

14. The picture decoding method according to claim 10 or 11, wherein the interpolation coefficient determining step excludes one of the interpolation reference pixels from the interpolation reference pixels by designating an interpolation coefficient as zero if a magnitude of a difference between the reference picture depth information for one of the interpolation reference pixels and the object depth information is greater than a predetermined threshold value, and determines an interpolation coefficient based on the difference and a distance between one of the interpolation reference pixels and an integer pixel or a fractional pixel on the reference picture indicated by the correspondence point if the magnitude of the difference is within the predetermined threshold value.

15. A picture encoding apparatus for performing encoding while predicting a picture between a plurality of views using a reference picture encoded for a view different from a view of an encoding target picture and reference picture depth information which is depth information of an object in the reference picture when a multiview picture which includes pictures from the views is encoded, the apparatus comprising:
a correspondence point setting unit which sets a correspondence point on the reference picture for each pixel of the encoding target picture;
an object depth information setting unit which sets object depth information which is depth information for a pixel at an integer pixel position on the encoding target picture indicated by the correspondence point;
an interpolation tap length determining unit which determines a tap length for pixel interpolation using the reference picture depth information for a pixel at an integer pixel position or an integer pixel position around a fractional pixel position on the reference picture indicated by the correspondence point and the object depth information;
a pixel interpolating unit which generates a pixel value at the integer pixel position or the fractional pixel position on the reference picture indicated by the correspondence point using an interpolation filter in accordance with the tap length; and
an inter-view picture predicting unit which performs inter-view picture prediction by setting the pixel value generated by the pixel interpolating unit as a predicted value of the pixel at the integer pixel position on the encoding target picture indicated by the correspondence point.

16. A picture encoding apparatus for performing encoding while predicting a picture between a plurality of views using a reference picture encoded for a view different from a view of an encoding target picture and reference picture depth information which is depth information of an object in the reference picture when a multiview picture which includes pictures from the views is encoded, the apparatus comprising:
a correspondence point setting unit which sets a correspondence point on the reference picture for each pixel of the encoding target picture;
an object depth information setting unit which sets object depth information which is depth information for a pixel at an integer pixel position on the encoding target picture indicated by the correspondence point;
an interpolation reference pixel setting unit which sets pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information;
a pixel interpolating unit which generates a pixel value at the integer pixel position or the fractional pixel position on the reference picture indicated by the correspondence point in accordance with a weighted sum of pixel values of the interpolation reference pixels; and
an inter-view picture predicting unit which performs inter-view picture prediction by setting the pixel value generated by the pixel interpolating unit as a predicted value of the pixel at the integer pixel position on the encoding target picture indicated by the correspondence point.

17. A picture decoding apparatus for performing decoding while predicting a picture between views using a decoded reference picture and reference picture depth information which is depth information of an object in the reference picture when a decoding target picture of a multiview picture is decoded, the apparatus comprising:
a correspondence point setting unit which sets a correspondence point on the reference picture for each pixel of the decoding target picture;
an object depth information setting unit which sets object depth information which is depth information for a pixel at an integer pixel position on the decoding target picture indicated by the correspondence point;
an interpolation tap length determining unit which determines a tap length for pixel interpolation using the reference picture depth information for a pixel at an integer pixel position or an integer pixel position around a fractional pixel position on the reference picture indicated by the correspondence point and the object depth information;
a pixel interpolating unit which generates a pixel value at the integer pixel position or the fractional pixel position on the reference picture indicated by the correspondence point using an interpolation filter in accordance with the tap length; and
an inter-view picture predicting unit which performs inter-view picture prediction by setting the pixel value generated by the pixel interpolating unit as a predicted value of the pixel at the integer pixel position on the decoding target picture indicated by the correspondence point.

18. A picture decoding apparatus for performing decoding while predicting a picture between views using a decoded reference picture and reference picture depth information which is depth information of an object in the reference picture when a decoding target picture of a multiview picture is decoded, the apparatus comprising:
a correspondence point setting unit which sets a correspondence point on the reference picture for each pixel of the decoding target picture;
an object depth information setting unit which sets object depth information which is depth information for a pixel at an integer pixel position on the decoding target picture indicated by the correspondence point;
an interpolation reference pixel setting unit which sets pixels at integer pixel positions of the reference picture for use in pixel interpolation as interpolation reference pixels using the reference picture depth information for a pixel at an integer pixel position or an integer pixel position around a fractional pixel position on the reference picture indicated by the correspondence point and the object depth information;
a pixel interpolating unit which generates a pixel value at the integer pixel position or the fractional pixel position on the reference picture indicated by the correspondence point in accordance with a weighted sum of pixel values of the interpolation reference pixels; and
an inter-view picture predicting unit which performs inter-view picture prediction by setting the pixel value generated by the pixel interpolating unit as a predicted value of the pixel at the integer pixel position on the decoding target picture indicated by the correspondence point.

19. A picture encoding program for causing a computer to execute the picture encoding method according to any one of claims 1 to 4.

20. A picture decoding program for causing a computer to execute the picture decoding method according to any one of claims 8 to 11.

21. A computer-readable recording medium recording the picture encoding program according to claim 19.

22. A computer-readable recording medium recording the picture decoding program according to claim 20.
